(19) United States
(12) Patent Application Publication
(10) Pub. No.: US 2017/0357630 A1
(43) Pub. Date: Dec. 14, 2017

(54) Tibetan Spelling Check Method And Device Based On Automata

(71) Applicant: Nima Zhaxi, Lhasa City (CN)

(72) Inventor: Nima Zhaxi, Lhasa City (CN)

(21) Appl. No.: 15/337,047

(22) Filed: Oct. 28, 2016

(30) Foreign Application Priority Data
Jun. 13, 2016 (CN) 201610409221.3

(51) Int. Cl. G06F 17/27; G06F 17/22

(52) U.S. Cl. CPC G06F 17/273; G06F 17/2223; G06F 17/274; G06F 17/2705

(57) ABSTRACT

The present invention discloses a Tibetan spelling check method and device based on automata, and relates to the field of natural language processing. The present invention is proposed to solve the problem in the prior art that as the application range is relatively narrow, some Tibetan characters with special structures cannot be recognized. The technical solution provided by the embodiments of the present invention includes: S10, segmenting a Tibetan text to be checked with an character as a unit to acquire at least one Tibetan character; S20, using the at least one Tibetan character as the input of a preset finite state automaton group; and S30, judging whether the Tibetan text to be checked is correctly spelled through the finite state automaton group.

### CROSS-REFERENCE TO RELATED APPLICATIONS

This application claims the benefit and priority of Chinese Patent Application No. 201610409221.3 filed Jun. 13, 2016. The entire disclosure of the above application is incorporated herein by reference.

### FIELD

The present invention relates to the field of natural language processing, in particular to a Tibetan spelling check method and device based on automata.

### BACKGROUND

In natural language processing technology, large data processing technology and some word processing software, in order to solve the problem of misspellings generated by users in a writing process, a spelling check function is usually available to enable the users to check the misspellings in the writing process.

In the prior art, a spelling check method used in the Tibetan field is mainly to establish a model corresponding to Tibetan character rules, and Tibetan spelling check is carried out via the model.

However, when the model is applied to the spelling check, as the application range of the model is relatively narrow, some Tibetan characters with special structures cannot be recognized.

### SUMMARY

The present invention provides a Tibetan character spelling check method and device based on automata, which can expand the application range of spelling check and improve the recognition rate of Tibetan characters.

On one aspect, a Tibetan character spelling check method based on automata is provided, including: S10, segmenting a Tibetan text to be checked with an character as a unit to acquire at least one Tibetan character; S20, using the at least one Tibetan character as the input of a preset finite state automaton group; and S30, judging whether the Tibetan text to be checked is correctly spelled through the finite state automaton group, wherein the finite state automaton group includes 37 finite state automata, and any finite state automaton Mᵢ=(Σᵢ, Qᵢ, δᵢ, qᵢ, Fᵢ); the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ, and Fᵢ⊂Qᵢ; and the i is a positive integer, and i≦37.

On the other aspect, a Tibetan character spelling check device based on automata is provided, including:

a segmenting module, used for segmenting a Tibetan text to be checked with an character as a unit to acquire at least one Tibetan character;

an input module, used for using the at least one Tibetan character as the input of a preset finite state automaton group;

a spelling check module, used for judging whether the Tibetan text to be checked is correctly spelled through the finite state automaton group;

the finite state automaton group includes 37 finite state automata, wherein any finite state automaton Mᵢ=(Σᵢ, Qᵢ, δᵢ, qᵢ, Fᵢ); the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ, and Fᵢ ⊂Qᵢ; and the i is a positive integer, and i≦37.

The present invention has the following beneficial effects: the Tibetan text to be checked is used as the input of the finite state automaton group to achieve Tibetan spelling check. As the finite state automaton group corresponds to the Tibetan spelling formal grammar, the technical solutions provided by the embodiments of the present invention can solve the problem in the prior art that when the spelling check is carried out by a model, as the application range of the model is relatively narrow, some Tibetan characters with special structures cannot be recognized.

### DRAWINGS

FIG. 1 is a flowchart of a Tibetan spelling check method based on automata provided by a first embodiment of the present invention;

FIG. 2 is a flowchart of a Tibetan spelling check method based on automata provided by a second embodiment of the present invention;

FIG. 3 is a flowchart of a Tibetan spelling check method based on automata provided by a third embodiment of the present invention;

FIG. 4 is a schematic diagram of a structure of a Tibetan spelling check device based on automata provided by a fourth embodiment of the present invention.

### DETAILED DESCRIPTION

The present invention will be further illustrated below in combination with accompanying drawings and embodiments. But the usage and the objective of these exemplary implementations are merely used for citing the present invention, but do not constitute any form of limitation to the actual protection scope of the present invention, let alone limit the protection scope of the present invention hereto.

### First Embodiment

As shown in FIG. 1, the embodiment of the present invention provides a Tibetan spelling check method based on automata, including the following steps.

Step 101, a Tibetan text to be checked is segmented with an character as a unit to acquire at least one Tibetan character.

In the embodiment, in the step 101, the Tibetan text to be checked can be segmented with an character as a unit according to a Tibetan character separator, a vertical character, a double-vertical character and a space character to acquire at least one Tibetan character.

Wherein, the Tibetan text to be checked can only contain one Tibetan character and can also contain a plurality of Tibetan characters, and this is not limited herein.

Step 102, the at least one Tibetan character is used as the input of a preset finite state automaton group.

In the embodiment, the finite state automaton group includes 37 finite state automata, wherein any finite state automaton Mᵢ=(Σᵢ, Qᵢ, δᵢ, qᵢ, Fᵢ); the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ and the Fᵢ; the δᵢ represents a state transition function of the finite state automaton M₁ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ, and Fᵢ⊂Qᵢ; and the is a positive integer, and i≦37.

In the embodiment, 37 Tibetan spelling formal grammars are preset, and each Tibetan spelling formal grammar corresponds to one finite state automaton; and the at least one Tibetan character is used as the input of each finite state automaton in sequence. The finite set of the terminal symbols of the Tibetan spelling formal grammar Gᵢ is a subset of a set L consisting of 30 Tibetan consonants, 5 reverse scripts, 4 vowel symbols and 1 long vowel symbol, and includes characters (symbols) actually occurring in a sentence (a Tibetan character belonging to a certain structure) of the language; the set of the non-terminal symbols of the Tibetan spelling formal grammar Gᵢ includes words that do not actually occur in the sentence of the language, but play the function of variables in deduction, and are equivalent to the grammatical category in the language. For example, the non-terminal symbol can be a variable of an SVO (Subject Verb Object) word order of the Chinese, the SOV (Subject Object Verb) word order of the Tibetan and other grammars, but it does not occur in a specific sentence, that is, it implicitly works, but cannot be seen.

Elements in the finite set of the terminal symbols and the finite set of the non-terminal symbols correspond to specific Tibetan spelling formal grammars. The initial state of the finite state automaton Mᵢ is a state in which the automation just starts to work, and this state is a state in which the automaton primarily receives input characters; and the termination state refers to a final state of the automaton. Specifically, the automata in the finite state automaton group can be a determined type and can also be an undetermined type; and to facilitate the understanding and improve the implementation efficiency, the automata of the determined types provided by the embodiment are taken as an example for illustration.

Step 103, whether the Tibetan text to be checked is correctly spelled is judged through the finite state automaton group.

In the embodiment, the process in the step 103 of judging whether the Tibetan text to be checked is correctly spelled can include: each finite state automaton in the finite state automaton group sequentially receives at least one Tibetan character from the initial state and transfers the state; if a certain finite state automaton in the finite state automaton group can enter the termination state after transferring the state, the Tibetan text to be checked is correctly spelled; if none of the finite state automata in the finite state automaton group can enter the termination state after transferring the state, the Tibetan text to be checked is wrongly spelled. For example, the operation of transferring the state can be as follows: the finite state automaton Mᵢ receives a certain input character at a certain state, for example, qₘ(qₘεQᵢ), if x (xεΣᵢ), if the state transition function δₘ (qₘ, x)ε(δᵢ, then the automaton enters the state qₘ₊₁(qₘ₊₁ε(qₘ, x)), and otherwise, the state of the automaton is not changed.

The present invention has the following beneficial effects: the Tibetan text to be checked is used as the input of the finite state automaton group to achieve Tibetan spelling check. As the finite state automaton group corresponds to the Tibetan spelling formal grammar, the technical solutions provided by the embodiments of the present invention can solve the problem in the prior art that when the spelling check is carried out by a model, as the application range of the model is relatively narrow, some Tibetan characters with special structures cannot be recognized.

### Second Embodiment

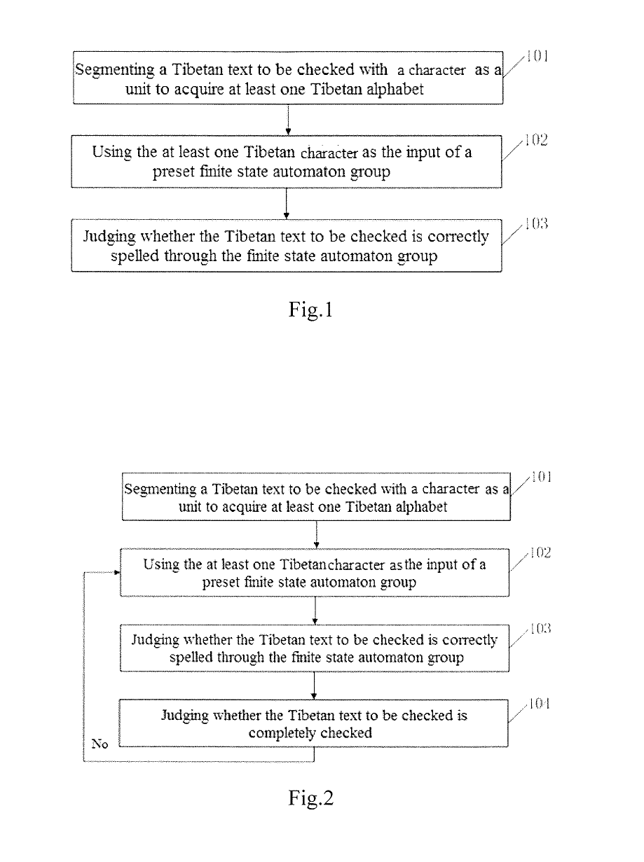

As shown in FIG. 2, the embodiment of the present invention provides a Tibetan spelling check method based on automata. The method is similar to the method as shown in FIG. 1, the difference lies in that, to complete the spelling check of the entire Tibetan text, the Tibetan spelling check method provided by the embodiment further includes:

step 104, whether the Tibetan text to be checked is completely checked is judged.

In the embodiment, when it is determined that the Tibetan text to be checked is completely checked in the step 104, the current Tibetan spelling check is terminated; when it is determined that the Tibetan text to be checked is not completely checked in the step 104, step 102 is continuously executed on the unchecked part of the Tibetan text to be checked until the Tibetan text to be checked is completely checked.

The present invention has the following beneficial effects: the Tibetan text to be checked is used as the input of the finite state automaton group to achieve Tibetan spelling check. As the finite state automaton group corresponds to the Tibetan spelling formal grammar, the technical solutions provided by the embodiments of the present invention can solve the problem in the prior art that when the spelling check is carried out by a model, as the application range of the model is relatively narrow, some Tibetan characters with special structures cannot be recognized.

### Third Embodiment

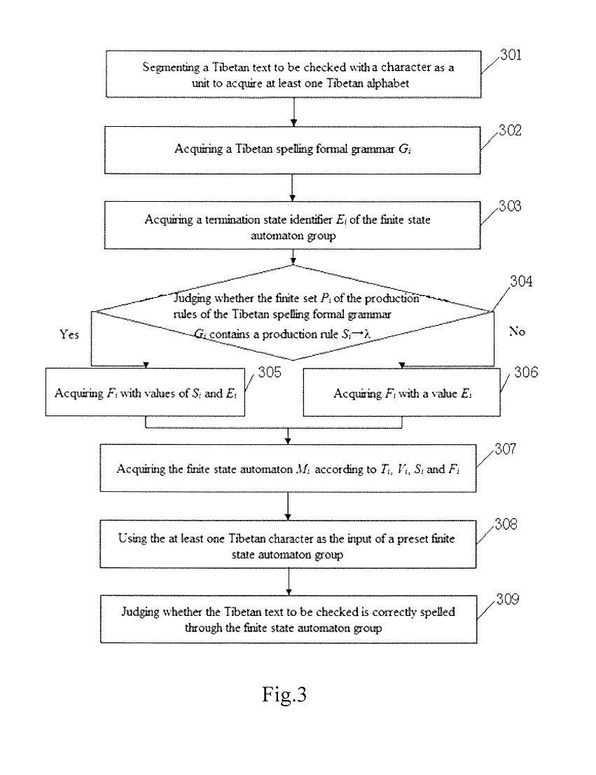

As shown in FIG. 3, the embodiment of the present invention provides a Tibetan spelling check method based on automata, including the following steps.

Step 301, a Tibetan text to be checked is segmented with an character as a unit to acquire at least one Tibetan character. The process is similar to the step 101 as shown in FIG. 1, and thus will not be repeated redundantly herein.

Step 302, a Tibetan spelling formal grammar Gᵢ is acquired.

In the embodiment, in the step 302, the Tibetan spelling formal grammar Gᵢ=(Tᵢ, Vᵢ, Sᵢ, Pᵢ). The process of acquiring the Tibetan spelling formal grammar through the step 302 includes: acquiring a finite set Tᵢ of terminal symbols, wherein the Tᵢ is a subset of a set L, and the set L includes 30 Tibetan consonants, 5 reverse scripts, 4 vowel symbol s and 1 long vowel symbol; acquiring a finite set Vᵢ of non-terminal symbols; acquiring a start symbol Sᵢ, wherein SᵢεVᵢ; acquiring a finite set Pᵢ of production rules; and acquiring the corresponding Tibetan spelling formal grammar Gᵢ according to the Tᵢ, Vᵢ, Sᵢ and Pᵢ. Wherein, the process of acquiring the finite set Pᵢ of the production rules can include: at first, acquiring a preset Tibetan spelling grammar formal description system; and then acquiring the finite set Pᵢ of the production rules according to the Tibetan spelling grammar formal description system.

In the embodiment, the preset Tibetan spelling grammar formal description system can be established according to a set theory method, and the specific form is as follows:

Tibetan spelling grammar 1: elements in a set Root={b₁, b₂, b₃, b₄, b₅, . . . , b₃₀, b₃₁, b₃₂, b₃₃, b₃₄, b₃₅} respectively correspond to 30 Tibetan consonants and 5 Tibetan reverse scripts, and then any Tibetan character corresponding to bᵢεRoot can constitute a root of a Tibetan character.

Tibetan spelling grammar 2: for a set Prefix={b₃, b₁₁, b₁₅, b₁₆, b₂₃}, Prefix⊂Root, any Tibetan character corresponding to bᵢεPrefix, (j=3, 11, 15, 16, 23) can constitute a prefix of the Tibetan character.

Tibetan spelling grammar 3: for a set Suffix={b₃, b₄, b₁₁, b₁₂, b₁₅, b₁₆, b₂₃, b₂₅, b₂₆, b₂₈}, Suffix⊂Root, any Tibetan character corresponding to bᵢεSuffix, (j=3, 4, 11, 12, 15, 16, 23, 25, 26, 28) can constitute a suffix of the Tibetan character.

Tibetan spelling grammar 4: for a set Postfix={b₁₁, b₂₈}, Postfix⊂Suffix ⊂Root, any Tibetan character corresponding to bᵢεPostfix, (j=11, 28) can constitute a postfix of the Tibetan character.

Tibetan spelling grammar 5: for a set Superfix={b₂₅, b₂₆, b₂₈}, Superfix⊂Root, any Tibetan character corresponding to bᵢεSuperfix, (j=25, 26, 28) can constitute a superfix of the Tibetan character.

Tibetan spelling grammar 6: for a set Subfix={b₂₀, b₂₄, b₂₅, b₂₆}, Subfix⊂Root, any Tibetan character corresponding to bᵢεSubfix, (j=20, 24, 25, 26) can constitute a subfix of the Tibetan character.

Tibetan spelling grammar 7: for a set Vowel=Vowel₁{a}, Vowel₁={i, u, e, o} corresponds to 4 Tibetan vowel characters, and a represents a Tibetan long vowel character. The Tibetan roots corresponding to bⱼεRoot, (j=1, 23, 5, 7, . . . , 33, 34, 35) can be spelled with vowel characters corresponding to vεVowel, u and a can only be spelled below consonants, and the rest 3 vowel characters can only be spelled above the consonants.

Tibetan spelling grammar 8: when the Tibetan roots corresponding to bⱼεRoot, (j=1, 3, 4, 5, 7, 8, 9, 11, 12, 13, 15, 16, 17, 19, 29) are spelled with the superfixes corresponding to bᵢεSuperfix, (i=25, 26, 28), the following grammar rules must be satisfied:

1. bⱼεRoot, (j=1, 3, 4, 7, 8, 9, 11, 12, 15, 16, 17, 19) can only be spelled with b₂₅εSuperfix.

2. bⱼεRoot, (j=1, 3, 4, 5, 7, 9, 11, 13, 15, 29) can only be spelled with b₂₆εSuperfix.

3. bⱼεRoot, (j=1, 3, 4, 8, 9, 11, 12, 13, 15, 16, 17) can only be spelled with b₂₈εSuperfix.

Tibetan spelling grammar 9: when the Tibetan roots corresponding to bⱼεRoot, (j=1, 2, 3, 8, 9, 10, 11, 13, 14, 15, 16, 18, 21, 22, 25, 26, 27, 28, 29) are spelled with the subfixes corresponding to bᵢεSubfix, (i=20, 24, 25, 26), the following grammar rules must be satisfied:

1. bⱼεRoot, (j=1, 2, 3, 8, 11, 18, 21, 22, 25, 26, 27, 29) can only be spelled with b₂₀εSubfix.

2. bⱼεRoot, (j=1, 2, 3, 13, 14, 15, 16) can only be spelled with b₂₄εSubfix.

3. bⱼεRoot, (j=1, 2, 3, 9, 10, 11, 13, 14, 15, 16, 28, 29) can only be spelled with b₂₅εSubfix.

4. bⱼεRoot, (j=1, 3, 15, 22, 25, 28) can only be spelled with b₂₆εSubfix.

5. bⱼεRoot, (j=29) can only be spelled with b₁₄εSubfix.

(Note: to spell the [1] phonetic symbol in other languages, b₂₉ and b₁₄ spelling forms occur in the modern Tibetan. According to the traditional Tibetan spelling grammar, b₂₉ cannot be used as the superfix, and b₁₄ cannot be used as the subfix neither, therefore, as a special condition, when b₂₉ is spelled with b₁₄, b₁₄ is deemed as the “subfix”.)

Tibetan spelling grammar 10: when the Tibetan roots corresponding to bᵢεRoot, (i=1, 3, 12, 13, 15, 16, 17) are simultaneously spelled with the superfixes corresponding to bⱼεSuperfix, (j=25, 28) and the subfixes corresponding to bₖεSubfix, (k=20, 24, 25), the following grammar rules must be satisfied:

1. when being spelled with b₂₅εSuperfix, b₁εRoot can be simultaneously spelled with b₂₄εSubfix; and when being spelled with b₂₈εSuperfix, b₁εRoot can be simultaneously spelled with bₖεSubfix, (k=24, 25).

2. When being spelled with b₂₅εSuperfix, b₃εRoot can be simultaneously spelled with b₂₄εSubfix; and when being spelled with b₂₈εSuperfix, b₃εRoot can be simultaneously spelled with bₖεSubfix, (k=24, 25).

3. When being spelled with b₂₈εSuperfix, b₁₂εRoot can be simultaneously spelled with b₂₅εSubfix.

4. When being spelled with b₂₈εSuperfix, b₁₃εRoot can be simultaneously spelled with bₖεSubfix, (k=24, 25).

5. When being spelled with b₂₈εSuperfix, b₁₅εRoot can be simultaneously spelled with bₖεSubfix, (k=24, 25).

6. When being spelled with b₂₅εSuperfix, b₁₆εRoot can be simultaneously spelled with b₂₄εSubfix; and when being spelled with b₂₈εSuperfix, b₁₆εRoot can be simultaneously spelled with bₖεSubfix, (k=24, 25).

7. When being spelled with b₂₅εSuperfix, b₁₇εRoot can be simultaneously spelled with b₂₀εSubfix.

Tibetan spelling grammar 11: when the Tibetan roots corresponding to bᵢεRoot, (i=1, 3, 4, 7, 8, 9, 11, 12, 17, 19) are simultaneously spelled with the prefixes corresponding to b₁₅εPrefix and the superfixes corresponding to bⱼεSuperfix, (j=25, 26, 28), the following grammar rules must be satisfied:

1. bᵢεRoot, (i=1, 3, 4, 7, 8, 9, 11, 12, 17, 19) can be spelled with b₂₅εSuperfix.

2. bᵢεRoot, (i=9,11) can be spelled with b₂₆εSuperfix.

3. bᵢεRoot, (i=1, 3, 4, 8, 9, 11, 12, 17) can be spelled with b₂₈εSuperfix.

Tibetan spelling grammar 12: when the Tibetan roots corresponding to bᵢεRoot, (i=1, 2, 3, 11, 13, 14, 15, 16, 22, 25, 28) are simultaneously spelled with the prefixes corresponding to bⱼεPrefix, (j=11, 15, 16, 23) and the subfixes corresponding to bₖεSubfix, (k=20, 24, 25, 26), the following grammar rules must be satisfied:

1. bᵢεRoot, (i=1, 3, 13, 15, 16) can be spelled with b₁₁εPrefix and b₂₄εSubfix.

2. bᵢεRoot, (i=1, 3, 13, 15) can be spelled with b₁₁εPrefix and b₂₅εSubfix.

3. bᵢεRoot, (i=1, 3) can be spelled with b₁₅εPrefix and b₂₄εSubfix.

4. bᵢεRoot, (i=1, 3, 28) can be spelled with b₁₅εPrefix and b₂₅εSubfix.

5. bᵢεRoot, (i=1, 22, 25, 28) can be spelled with b₁₅εPrefix and b₂₆εSubfix.

6. bᵢεRoot, (i=2, 3) can be spelled with b₁₆εPrefix and bₖεSubfix, (k=24,25).

7. bᵢεRoot, (i=2, 3, 14, 15) can be spelled with b₂₃εPrefix and b₂₄εSubfix.

8. bᵢεRoot, (i=2, 3, 11, 14, 15) can be spelled with b₂₃εPrefix and b₂₅εSubfix.

Tibetan spelling grammar 13: when the Tibetan roots corresponding to bᵢεRoot, (i=1, 3) are spelled with the prefixes corresponding to b₁₅εPrefix, the superfixes corresponding to bⱼεSuperfix, (i=25, 28) and the subfixes corresponding to bₖεSubfix, (i=24, 25), the following grammar rules must be satisfied:

1. bᵢεRoot, (i=1, 3) can be spelled with b₁₅εPrefix, b₂₅εSuperfix and b₂₄εSubfix.

2. bᵢεRoot, (i=1, 3) can be spelled with b₁₅εPrefix, b₂₈εSuperfix and b₂₅εSubfix.

3. bᵢεRoot, (i=1, 3) can be spelled with b₁₅εPrefix, b₂₈εSuperfix and b₂₄εSubfix.

Tibetan spelling grammar 14: when being spelled with the prefixes corresponding to bⱼεPrefix, (j=3, 11, 15, 16, 23), the Tibetan roots corresponding to bᵢεRoot, (i=1, 2, 3, 4, 5, 6, 7, 8, 9, 10, 11, 12, 13, 14, 15, 16, 17, 18, 19, 21, 22, 24, 27, 28) must be simultaneously spelled with the vowel symbols corresponding to vεVowel, Vowel={i, u, e, o}, or one suffix corresponding to bₖεSuffix, (k=3, 4, 11, 12, 15, 16, 23, 25, 26, 28), and the following grammar rules must be satisfied:

1. bᵢεRoot, (i=5, 8, 9, 11, 12, 17, 21, 22, 24, 27, 28) can only be spelled with b₃εPrefix.

2. bᵢεRoot, (i=1, 3, 4, 13, 15, 16) can only be spelled with b₁₁εPrefix.

3. bᵢεRoot, (i=1, 3, 5, 9, 11, 17, 21, 22, 27, 28) can only be spelled with b₁₅εPrefix.

4. bᵢεRoot, (i=2, 3, 4, 6, 7, 8, 10, 11, 12, 18, 19) can only be spelled with b₁₆εPrefix.

5. bᵢεRoot, (i=2, 3, 6, 7, 10, 11, 14, 15, 18, 19) can only be spelled with b₂₃εPrefix.

Tibetan spelling grammar 15: the Tibetan roots corresponding to bᵢεRoot, (j=1, 2, 3, 4, 5, 6, 7, 8, 9, 10, . . . , 21, 22, 23, 24, 25, 26, 27, 28, 29, 30) can be spelled with any suffix corresponding to bᵢεSuffix, (i=3, 4, 11, 12, 15, 16, 23, 25, 26, 28).

Tibetan spelling grammar 16: the use of the Tibetan postfixes is only related to the suffixes. The Tibetan suffixes corresponding to bᵢεSuffix, (i=3, 4, 12, 15, 16, 25, 26) can be spelled with the postfixes corresponding to bⱼεPostfix, (j=11, 28), and the following grammar rules must be satisfied:

1. b₁₁εPostfix can only be spelled with bᵢεSuffix, (i=12, 25, 26).

2. b₂₈εPostfix can only be spelled with bᵢεSuffix, (i=3, 4, 15, 16).

Tibetan spelling grammar 17: when being spelled with the Tibetan subfixes corresponding to bᵢεSubfix, (j=24, 25), the Tibetan roots corresponding to bᵢεRoot, (i=3, 11, 14) can be simultaneously spelled with the Tibetan subfixes corresponding to b₂₀εSubfix. The specific rules are as follows:

1. when being spelled with b₂₅εSubfix, bᵢεRoot, (i=3, 11) can be simultaneously spelled with b₂₀εSubfix.

2. When being spelled with b₂₄εSubfix, b₁₄εRoot can be simultaneously spelled with b₂₀εSubfix.

Tibetan spelling grammar 18: the Tibetan consonants corresponding to b₂₉εRoot can be spelled with the Tibetan consonants corresponding to b₁₄εRoot, and b₁₄εRoot is correspondingly located below b₂₉εRoot.

Tibetan spelling grammar 19: when being spelled with the Tibetan consonants corresponding to b₁₄εRoot, the Tibetan consonants corresponding to b₂₉εRoot can be simultaneously spelled with the Tibetan suffixes corresponding to bᵢεSuffix, (i=3, 4, 11, 12, 15, 16, 23, 25, 26, 28).

Tibetan spelling grammar 20: the Tibetan characters having no suffix can be spelled with the Tibetan consonants corresponding to b₂₃εRoot, and at this time, the Tibetan consonants corresponding to b₂₃εRoot must be spelled with the vowel symbols (i, e, u, o) corresponding to vεVowel, Vowel={i, u, e, o}.

Tibetan spelling grammar 21: besides the special spelling in the grammars 17, 18, 19 and 20, the Tibetan characters are spelled according to the sequence of the prefixes, the superfixes, the roots, the subfixes, the vowel symbols, the suffixes and the postfixes.

In the embodiment, Tᵢ represents the finite set of the terminal symbols of the Tibetan spelling formal grammar Gᵢ; Sᵢ represents the start symbol of the Tibetan spelling formal grammar Gᵢ; SᵢεVᵢ; λ represents a null character; the finite set Σᵢ of the input characters of the finite state automaton A is equivalent to the finite set Tᵢ of the terminal symbols of the Tibetan spelling formal grammar Gᵢ; and the initial state qᵢ of the finite state automaton Mᵢ is equivalent to the start symbol Sᵢ of the Tibetan spelling formal grammar Gᵢ. Wherein, Sᵢ represents any possible sentence (it is a Tibetan character in the application herein) in the language L (Gᵢ) generated by the grammar Sᵢ, so Sᵢ is a special non-terminal symbol.

Specifically, the specific forms of the 37 Tibetan spelling formal grammars G₁ to G₃₇ are as follows:

Tibetan spelling formal grammar G_{1:} the spelling formal grammar G₁ of the Tibetan roots and the vowel symbols is a quadruple (T₁, V₁, S₁, P₁), wherein:

(1) terminal symbol

T₁=T_{B}∪Tₒ, wherein:

T_{B}={b₁, b₂, b₃, b₄, b₅, . . . , b₃₅}, the elements thereof correspond to the Tibetan consonant characters; and Tₒ={i,u,e,o,a}, the elements thereof correspond to the Tibetan vowel characters;

(2) non-terminal symbol set

V₁={S₁,B_{1,1},B_{1,2}};

(3) S₁ is a non-terminal symbol in V₁ and is a start symbol; and

(4) a production set of the grammar G₁ is: P₁={

S₁→b₁|b₂|b₃|b₄|b₅| . . . |b₃₀|b₃₁|b₃₂|b₃₃|b₃₄|b₃₅,

S₁→b₁B_{1,1}|b₂B_{1,1}|b₃B_{1,1}|b₄B_{1,1}|b₅B_{1,1}| . . . |b₃₀B_{1,1},

S₁→b₃₁B_{1,2}|b₃₂B_{1,2}|b₃₃B_{1,2}|b₃₄B_{1,2}|b₃₅B_{1,2},

B_{1,1}→i|u|e|o|a,

B_{1,2}→i|u|e|o}

With respect to a Tibetan spelling structure 2:

Tibetan spelling formal grammar G₂ the spelling formal grammar G₂ of the Tibetan superfixes, the roots and the vowels is a quadruple (T₂, V₂, S₂, P₂), wherein:

(1) terminal symbol

T₂=T_{B}∪Tₒ, wherein:

T_{B}={b₁,b₃,b₄,b₅,b₇,b₈,b₉,b₁₁,b₁₂,b₁₃,b₁₅,b₁₆,b₁₇,b₁₉,b₂₅,b₂₆,b₂₈,b₂₉}, the elements thereof correspond to the Tibetan consonant characters; and Tₒ={i,u,e,o}, the elements thereof correspond to the Tibetan vowel characters;

(2) non-terminal symbol set

V₂={S₂,B_{2,1},B_{2,2},B_{2,3},B_{2,4}}

(3) S₂ is a non-terminal symbol in V₂ and is the start symbol;

(4) the production set of the grammar G₂ is: P₂={

S₂→b₂₅B_{2,1}|b₂₆B_{2,2}|b₂₈B_{2,3},

B_{2,1}→b₁|b₃|b₄|b₇|b₈|b₉|b₁₁|b₁₂|b₁₅|b₁₆|b₁₇|b₁₉,

B_{2,1}→b₁B_{2,4}|b₃B_{2,4}|b₄B_{2,4}|b₇B_{2,4}|b₈B_{2,4}|b₉B_{2,4}|b₁₁B_{2,4}|b₁₂B_{2,4}|b₁₅B_{2,4}|b₁₆B_{2,4}|b₁₇B_{2,4}|b₁₉B_{2,4},

B_{2,2}→b₁|b₃|b₄|b₅|b₇|b₉|b₁₁|b₁₃|b₁₅|b₂₉,

B_{2,2}→b₁B_{2,4}|b₃B_{2,4} b₄B_{2,4}|b₅B_{2,4}|b₇B_{2,4}|b₉B_{2,4}|b₁₁B_{2,4}|b₁₃B_{2,4}|b₁₅B_{2,4}|b₂₉B_{2,4},

B_{2,3}→b₁|b₃|b₄|b₈|b₉|b₁₁|b₁₂|b₁₃|b₁₅|b₁₆|b₁₇,

B_{2,3}→b₁B_{2,4}|b₃B_{2,4}|b₄B_{2,4}|b₈B_{2,4}|b₉B_{2,4}|b₁₁B_{2,4}|b₁₂B_{2,4}|b₁₃B_{2,4}|b₁₅B_{2,4}|b₁₆B_{2,4}|b₁₇B_{2,4},

B_{2,4}→i|u|e|o}

With respect to a Tibetan spelling structure 3:

Tibetan spelling formal grammar G_{3:} the spelling formal grammar G₃ of the Tibetan roots, the subfixes and the vowel symbols is a quadruple (T₃, V₃, S₃, P₃), wherein:

(1) terminal symbol

T₃=T_{B}∪Tₒ, wherein:

T_{B}={b₁,b₂,b₃,b₈,b₉,b₁₀,b₁₁,b₁₃,b₁₄,b₁₅,b₁₆,b₁₈,b₂₀,b₂₂,b₂₂,b₂₄,b₂₅,b₂₆,b₂₇,b₂₈,b₂₉}, the elements thereof correspond to the Tibetan consonant characters; and Tₒ={i,u,e,o}, the elements thereof correspond to the Tibetan vowel characters;

(2) non-terminal symbol set

V₃={S₃,B_{3,1},B_{3,2},B_{3,3},B_{3,4},B_{3,5},B_{3,6},B_{3,7},B_{3,8},B_{3,9},B_{3,10}},

(3) S₃ is a non-terminal symbol in V₃ and is the start symbol; and

(4) the production set of the grammar G₃ is: P₃={

S₃→b₁B_{3,1}|b₃B_{3,1},

S₃→b₂B_{3,2},

S₃→b₁₁B_{3,3}|b₂₉B_{3,3},

S₃→b₈B_{3,4}|b₁₈B_{3,4} b₂₁B_{3,4} b₂₆B_{3,4}|b₂₇B_{3,4},

S₃→b₉B_{3,5}|b₁₀B_{3,5},

S₃→b₁₃B_{3,6}|b₁₄B_{3,6}|b₁₆B_{3,6},

S₃→b₂₂B_{3,7}|b₂₅B_{3,7},

S₃→b₂₈B_{3,8},

S₃→b₁₅B_{3,9},

B_{3,1}→b₂₀|b₂₄|b₂₅|b₂₆,

B_{3,1}→b₂₀B_{3,10}|b₂₄B_{3,10}|b₂₅B_{3,10}|b₂₆B_{3,10},

B_{3,2}→b₂₀|b₂₄|b₂₅,

B_{3,2}→b₂₀B_{3,10}|b₂₄B_{3,10}|b₂₅B_{3,10},

B_{3,3}→b₂₀|b₂₅,

B_{3,3}→b₂₀B_{3,10}|b₂₅B_{3,10},

B_{3,4}→b₂₀,

B_{3,4}→b₂₀B_{3,10},

B_{3,5}→b₂₅,

B_{3,5}→b₂₅B_{3,10},

B_{3,6}→b₂₄|b₂₅,

B_{3,6}→b₂₄B_{3,10}|b₂₅B_{3,10},

B_{3,7}→b₂₀|b₂₆,

B_{3,7}→b₂₀B_{3,10}|b₂₆B_{3,10},

B_{3,8}→b₂₅|b₂₆,

B_{3,8}→b₂₅B_{3,10}|b₂₆B_{3,10},

B_{3,9}→b₂₄|b₂₅|b₂₆,

B_{3,9}→b₂₄B_{3,10}|b₂₅B_{3,10}|b₂₆B_{3,10},

B_{3,10}→i|u|e|o}

With respect to a Tibetan spelling structure 4:

Tibetan spelling formal grammar G_{4:} the spelling formal grammar G₄ of the superfixes, the Tibetan roots, the subfixes and the vowel symbols is a quadruple (T₄, V₄, S₄, P₄), wherein:

(1) terminal symbol

T₄=T_{B}∪Tₒ, wherein T_{B}={b₁,b₃,b₁₂,b₁₃,b₁₅,b₁₆,b₂₀,b₂₄,b₂₅,b₂₈}, the elements thereof correspond to the Tibetan consonant characters; and Tₒ={i,u,e,o}, the elements thereof correspond to the Tibetan vowel characters;

(2) non-terminal symbol set

V₄={S₄,B_{4,1},B_{4,2},B_{4,3},B_{4,4},B_{4,5},B_{4,6},B_{4,7}};

(3) S₄ is a non-terminal symbol in V₄ and is the start symbol; and

(4) the production set of the grammar G₄ is: P₄={

S₄→b₂₅B_{4,1},

S₄→b₂₈B_{4,2},

B_{4,1}→B_{4,3}|b₃B_{4,3}|b₁₆B_{4,3},

B_{4,1}→b₁₇B_{4,4},

B_{4,2}→b₁₂B_{4,5}|b₃B_{4,5}|b₁₃B_{4,5}|b₁₅B_{4,5}|b₁₆B_{4,5},

B_{4,2}→b₁₂B_{4,6},

B_{4,3}→b₂₄,

B_{4,3}→b₂₄B_{4,7},

B_{4,4}→b₂₀,

B_{4,4}→b₂₀B_{4,7},

B_{4,5}→b₂₄|b₂₅,

B_{4,5}→b₂₄B_{4,7}|b₂₅B_{4,7},

B_{4,6}→b₂₅,

B_{4,6}→b₂₅B_{4,7},

B_{4,7}→i|u|e|o}

With respect to a Tibetan spelling structure 5:

Tibetan spelling formal grammar G_{5:} the spelling formal grammar G₅ of the Tibetan prefixes, the superfixes, the roots and the vowel symbols is a quadruple (T₅, V₅, S₅, P₅), wherein:

(1) terminal symbol

T₅=T_{B}∪Tₒ, wherein:

T_{B}={b₁,b₃,b₄,b₇,b₈,b₉,b₁₁,b₁₂,b₁₅,b₁₇,b₁₉,b₂₅,b₂₆,b₂₈}, the elements thereof correspond to the Tibetan consonant characters; and Tₒ={i,u,e,o}, the elements thereof correspond to the Tibetan vowel characters;

(2) non-terminal symbol set

V₅={S₅,B_{5,1},B_{5,2},B_{5,3},B_{5,4},B_{5,5}};

(3) S₅ is a non-terminal symbol in V₅ and is the start symbol; and

(4) the production set of the grammar G₅ is: P₅={

S₅→b₁₅B_{5,1},

B_{5,1}→b₂₈B_{5,2},

B_{5,1}→b₂₆B_{5,3},

B_{5,1}→b₂₅B_{5,4},

B_{5,2}→b₁|b₃|b₄|b₈|b₉|b₁₁|b₁₂|b₁₇,

B_{5,2}→b₁B_{5,5}|b₃B_{5,5}|b₄B_{5,5}|b₈B_{5,5}|b₉B_{5,5}|b₁₁B_{5,5}|b₁₂B_{5,5}|b₁₇B_{5,5},

B_{5,3}→b₉|b₁₁,

B_{5,3}→b₉B_{5,5}|b₁₁B_{5,5},

B_{5,4}→b₁|b₃|b₄|b₇|b₈|b₉|b₁₁|b₁₂|b₁₇|b₁₉,

B_{5,4}→b₁B_{5,5}|b₃B_{5,5}|b₄B_{5,5}|b₇B_{5,5}|b₈B_{5,5}|b₉B_{5,5}|b₁₁B_{5,5}|b₁₂B_{5,5}|b₁₇B_{5,5}|b₁₉B_{5,5},

B_{5,5}→i|u|e|o}

With respect to a Tibetan spelling structure 6:

Tibetan spelling formal grammar G₆: the spelling formal grammar G₆ of the Tibetan prefixes, the roots, the subfixes and the vowels is a quadruple (T₆, V₆, S₆, P₆), wherein:

(1) terminal symbol

T₆=T_{B}∪Tₒ, wherein:

T_{B}={4b₂,b₃,b₁₁,b₁₃,b₁₄,b₁₅,b₁₆,b₂₂,b₂₃,b₂₄,b₂₅,b₂₆,b₂₈}, the elements thereof correspond to the Tibetan consonant characters; and Tₒ={i,u,e,o}, the elements thereof correspond to the Tibetan vowel characters;

(2) non-terminal symbol set

V₆={S₆,B_{6,1},B_{6,2},B_{6,3},B_{6,4},B_{6,5},B_{6,6},B_{6,7},B_{6,8},B_{6,9},B_{6,10},B_{6,11}};

(3) S₆ is a non-terminal symbol in V₆ and is the start symbol; and

(4) the production set of the grammar G₆ is: P₆={

S₆→b₁₁B_{6,1}|b₁₅B_{6,2}|b₁₆B_{6,3}|b₂₃B_{6,4},

B_{6,1}→b₁₆B_{6,5},

B_{6,1}→b₁B_{6,9}|b₃B_{6,9}|b₁₃B_{6,9}|b₁₅B_{6,9},

B_{6,2}→b₁B_{6,6},

B_{6,2}→b₂₂B_{6,7}|b₂₅B_{6,7},

B_{6,2}→b₂₈B_{6,8},

B_{6,2}→b₃B_{6,9},

B_{6,3}→b₂B_{6,9}|b₃B_{6,9},

B_{6,4}→b₂B_{6,9}|b₃B_{6,9}|b₁₄B_{6,9}|b₁₅B_{6,9},

B_{6,4}→b₁₁B_{6,10},

B_{6,5}→b₂₄,

B_{6,5}→b₂₄B_{6,11},

B_{6,6}→b₂₄|b₂₅|b₂₆,

B_{6,6}→b₂₄B_{6,11}|b₂₅B_{6,11}|b₂₆B_{6,11},

B_{6,7}→b₂₆,

B_{6,7}→b₂₆B_{6,11},

B_{6,8}→b₂₅|b₂₆,

B_{6,8}→b₂₅B_{6,11}|b₂₆B_{6,11},

B_{6,9}→b₂₄|b₂₅,

B_{6,9}→b₂₄B_{6,11}|b₂₅B_{6,11},

B_{6,10}→b₂₅,

B_{6,10}→b₂₅B_{6,11},

B_{6,11}→i|u|e|o}

With respect to a Tibetan spelling structure 7:

Tibetan spelling formal grammar G₇ the spelling formal grammar G₇ of the Tibetan prefixes, the superfixes, the roots, the subfixes and the vowel symbols is a quadruple (T₇, V₇, S₇, P₇), wherein:

(1) terminal symbol

T₇=T_{B}∪Tₒ, wherein:

T_{B}={b₁,b₃,b₁₅,b₂₄,b₂₅,b₂₈}, the elements thereof correspond to the Tibetan consonant characters; and Tₒ={i,u,e,o}, the elements thereof correspond to the Tibetan vowel characters;

(2) non-terminal symbol set

V₇={S₇,B_{7,2},B_{7,3},B_{7,4},B_{7,5},B_{7,6}};

(3) S₇ is a non-terminal symbol in V₇ and is the start symbol; and

(4) the production set of the grammar G₇ is: P₇={

S₇→b₁₅B_{7,1},

B_{7,1}→b₂₈B_{7,2},

B_{7,1}→b₂₅B_{7,3},

B_{7,2}→b₁B_{7,4}|b₃B_{7,4},

B_{7,3}→b₁B_{7,5}|b₃B_{7,5},

B_{7,4}→b₂₄|b₂₅,

B_{7,4}→b₂₄B_{7,6}|b₂₅B_{7,6},

B_{7,5}→b₂₄,

B_{7,5}→b₂₄B_{7,6},

B_{7,6}→i|u|e|o}

With respect to a Tibetan spelling structure 8:

Tibetan spelling formal grammar G₈; the spelling formal grammar G₈ of the Tibetan prefixes, the roots and the vowel symbols is a quadruple (T₈, V₈, S₈, P₈), wherein:

(1) terminal symbol

T₈=T_{B}∪Tₒ, wherein:

T_{B}={b₁,b₂,b₃,b₄,b₅,b₆,b₇,b₈,b₉,b₁₀,b₁₁,b₁₂,b₁₃,b₁₄,b₁₅,b₁₆,b₁₇,b₁₈,b₁₉,b₂₁,b₂₂,b₂₃,b₂₄,b₂₇,b₂₈}, the elements thereof correspond to the Tibetan consonant characters; and Tₒ={i,u,e,o}, the elements thereof correspond to the Tibetan vowel characters;

(2) non-terminal symbol set

V₈={S₈,B_{8,1},B_{8,2},B_{8,3},B_{8,4},B_{8,5},B_{8,6}};

(3) S₈ is a non-terminal symbol in V₈ and is the start symbol; and

(4) the production set of the grammar G₈ is: P₈={

S₈→b₃B_{8,1}|b₁₁B_{8,2}|b₁₅B_{8,3}|b₁₆B_{8,4}|b₂₃B_{8,5},

B_{8,1}→b₅B_{8,6}|b₈B_{8,6}|b₉B_{8,6}|b₁₁B_{8,6}|b₁₂B_{8,6}|b₁₇B_{8,6}|b₂₁B_{8,6}|b₂₂B_{8,6}|b₂₄B_{8,6}|b₂₇B_{8,6}|b₂₈B_{8,6},

B_{8,2}→b₁B_{8,6}|b₃B_{8,6}|b₄B_{8,6}|b₁₃B_{8,6}|b₁₅B_{8,6}|b₁₆B_{8,6},

B_{8,3}→b₁B_{8,6}|b₃B_{8,6}|b₅B_{8,6}|b₉B_{8,6}|b₁₁B_{8,6}|b₁₇B_{8,6}|b₂₁B_{8,6}|b₂₂B_{8,6}|b₂₇B_{8,6}|b₂₈B_{8,6},

B_{8,4}→b₂B_{8,6}|b₃B_{8,6}|b₄B_{8,6}|b₆B_{8,6}|b₇B_{8,6}|b₈B_{8,6}|b₁₀B_{8,6}|b₁₁B_{8,6}|b₁₂B_{8,6}|b₁₈B_{8,6}|b₁₉B_{8,6},

B_{8,5}→b₂B_{8,6}|b₃B_{8,6}|b₆B_{8,6}|b₇B_{8,6}|b₁₀B_{8,6}|b₁₁B_{8,6}|b₄B_{8,6}|b₁₅B_{8,6}|b₁₈B_{8,6}|b₁₉B_{8,6},

B_{8,6}→i|u|e|o}

With respect to a Tibetan spelling structure 9:

Tibetan spelling formal grammar G₉; the spelling formal grammar G₉ of the Tibetan prefixes, the roots, the vowel characters and the suffixes is a quadruple (T₉, V₉, S₉, P₉), wherein:

(1) terminal symbol

T₉=T_{B}∪Tₒ, wherein:

T_{B}={b₁,b₂,b₃,b₄,b₅,b₆,b₇,b₈,b₉,b₁₀,b₁₁|b₁₂,b₁₃,b₁₅,b₁₆,b₁₅,b₁₉,b₂₂,b₂₃,b₂₄,b₂₅,b₂₆,b₂₇,b₂₈}, the elements thereof correspond to the Tibetan consonant characters; and Tₒ={i,u,e,o}, the elements thereof correspond to the Tibetan vowel characters;

(2) non-terminal symbol set

V₉={S₉,B_{9,1},B_{9,2},B_{9,3},B_{9,4},B_{9,5},B_{9,7}};

(3) S₉ is a non-terminal symbol in V₉ and is the start symbol; and

(4) the production set of the grammar G₉ is: P₉={

S₉→b₃B_{9,1}|b₁₁B_{9,2}|b₁₅B_{9,3}|b₁₆B_{9,4}|b₂₃B_{9,5}, B_{9,1}→b₅B_{9,7}|b₈B_{9,7}|b₉B_{9,7}|b₁₁B_{9,7}|b₁₂B_{9,7}|b₁₇B_{9,7}|b₂₁B_{9,7}|b₂₂B_{9,7}|b₂₄B_{9,7}|b₂₇B_{9,7}|b₂₈B_{9,7},

B_{9,1}→b₅B_{9,6}|b₈B_{9,6}|b₉B_{9,6}|b₁₁B_{9,6}|b₁₂B_{9,6}|b₁₇B_{9,6}|b₂₁B_{9,6}|b₂₂B_{9,6}|b₂₄B_{9,6}|b₂₇B_{9,6}|b₂₈B_{9,6},

B_{9,2}→B_{9,7}|b₃B_{9,7}|b₄B_{9,7} b₁₃B_{9,7}|b₁₅B_{9,7}|b₁₆B_{9,7},

B_{9,2}→b₁B_{9,6}|b₃B_{9,6}|b₄B_{9,6}|b₁₃B_{9,6}|b₁₅B_{9,6}|b₁₆B_{9,6},

B_{9,3}→b₁B_{9,7}|b₃B_{9,7}|b₅B_{9,7}|b₉B_{9,7}|b₁B_{9,7}|b₁₇B_{9,7}|b₂₁B_{9,7}|b₂₂B_{9,7}|b₂₇B_{9,7}|b₂₈B_{9,7},

B_{9,3}→b₁B_{9,6}|b₃B_{9,6}|b₅B_{9,6}|b₉B_{9,6}|b₁₁B_{9,6}|b₁₇B_{9,6}|b₂₁B_{9,6}|b₂₂B_{9,6}|b₂₇B_{9,6}|b₂₈B_{9,6},

B_{9,4}→b₂B_{9,7}|b₃B_{9,7}|b₄B_{9,7}|b₆B_{9,7}|b₇B_{9,7}|b₈B_{9,7}|b₁₀B_{9,7}|b₁₁B_{9,7}|b₁₂B_{9,7} b₁₈B_{9,7}|b₁₉B_{9,7},

B_{9,4}→b₂B_{9,6}|b₃B_{9,6}|b₄B_{9,6}|b₆B_{9,6}|b₇B_{9,6}|b₈B_{9,6}|b₁₀B_{9,6}|b₁₁B_{9,6}|b₁₂B_{9,6}|b₁₈B_{9,6}|b₁₉B_{9,6},

B_{9,5}→b₂B_{9,7}|b₃B_{9,7}|b₆B_{9,7}|b₇B_{9,7}|b₁₀B_{9,7} i b₁B_{9,7}|b₁₄B_{9,7}|b₁₅B_{9,7}|b₁₈B_{9,7}|b₁₉B_{9,7},

B_{9,5}→b₂B_{9,6}|b₃B_{9,6}|b₆B_{9,6}|b₇B_{9,6}|b₁₀B_{9,6}|b₁₁B_{9,6}|b₁₄B_{9,6}|b₁₅B_{9,6}|b₁₈B_{9,6}|b₁₉B_{9,6},

B_{9,6}→iB_{9,7}|iB_{9,7}|uB_{9,7}|oB_{9,7},

B_{9,7}→b₃|b₄|b₁₁|b₁₂|b₁₅|b₁₆|b₂₃|b₂₅|b₂₆|b₂₈}

With respect to a Tibetan spelling structure 10:

Tibetan spelling formal grammar G_{10:} the spelling formal grammar G₁₀ of the Tibetan prefixes, the superfixes, the roots, the vowel symbols and the suffixes is a quadruple (T₁₀, V₁₀, S₁₀,B₁₀), wherein:

(1) terminal symbol

T₁₀=T_{B}∪Tₒ, wherein:

T_{B}={b₁,b₃,b₄,b₇,b₈,b₉,b₁₁,b₁₂,b₁₅,b₁₆,b₁₇,b₁₉,b₂₃,b₂₅,b₂₆,b₂₈}, the elements thereof correspond to the Tibetan consonant characters; and Tₒ={i,u,e,o}, the elements thereof correspond to the Tibetan vowel characters;

(2) non-terminal symbol set

(3) S₁₀ is a non-terminal symbol in V₁₀ and is the start symbol; and

(4) the production set of the grammar G₁₀ is: P₁₀={

S₁₀→b₁₅B_{10,1},

B_{10,1}→b₂₈B_{10,2}|b₂₆B_{10,3}|b₂₅B_{10,4},

B_{10,2}→b₁B_{10,6}|b₃B_{10,6}|b₄B_{10,6}|b₈B_{10,6}|b₉B_{10,6}|b₁₁B_{10,6}|b₁₂B_{10,6}|b₁₇B_{10,6},

B_{10,2}→b₁B_{10,5}|b₃B_{10,5}|b₄B_{10,5}|b₈B_{10,5}|b₉B_{10,5}|b₁₁B_{10,5}|b₁₂B_{10,5}|b₁₇B_{10,5},

B_{10,3}→b₉B_{10,6}|b₁₁B_{10,6},

B_{10,3}→b₉B_{10,5}|b₁₁B_{10,5},

B_{10,4}→b₁B_{10,6}|b₃B_{10,6}|b₄B_{10,6}|b₇B_{10,6}|b₈B_{10,6}|b₉B_{10,6}|b₁₁B_{10,6}|b₁₂B_{10,6}|b₁₇B_{10,6}|b₁₉B_{10,6},

B_{10,4}→b₁B_{10,5}|b₃B_{10,5}|b₄B_{10,5}|b₇B_{10,5}|b₈B_{10,5}|b₉B_{10,5}|b₁₁B_{10,5}|b₁₂B_{10,5}|b₁₇B_{10,5}|b₁₉B_{10,5},

B_{10,6}→b₃|uB_{10,6}|eB_{10,6}|oB_{10,6},

B_{10,6}→b₃|b₄|b₁₁|b₁₂|b₁₅|b₁₆|b₂₃|b₂₅|b₂₆|b₂₈}

With respect to a Tibetan spelling structure 11:

Tibetan spelling formal grammar G₁₁ the spelling formal grammar G₁₁ of the Tibetan prefixes, the roots, the subfixes, the vowel symbols and the suffixes is a quadruple (T₁₁, V₁₁, S₁₁, P₁₁), wherein:

(1) terminal symbol

T₁₁=T_{B}∪Tₒ, wherein:

T_{B}={b₁,b₂,b₃,b₄,b₁₁,b₁₂,B₁₃,b₁₄,b₁₅,b₁₆,b₂₂,b₂₃,b₂₄,b₂₅,b₂₆,b₂₈}, the elements thereof correspond to the Tibetan consonant characters; and Tₒ={i,u,e,o}, the elements thereof correspond to the Tibetan vowel characters;

(2) non-terminal symbol set

V₁₁={S₁₁,B_{11,1},B_{11,2},B_{11,3},B_{11,4},B₁₁,B_{11,6},B_{11,7},B_{11,8},B_{11,9},B_{11,10}B_{11,11},B_{11,12}};

(3) S₁₁ is a non-terminal symbol in V₁₁ and is the start symbol; and

(4) the production set of the grammar G₁₁ is: P₁₁={

S₁₁→b₁₁B_{11,1}|b₁₅B_{11,2}|b₁₆B_{11,3}|b₂₃B_{11,4},

B_{11,1}→b₆B_{11,5},

B_{11,1}→b₁B_{11,9}|b₃B_{11,9}|b₁₃B_{11,9}|b₁₅B_{11,9},

B_{11,2}→b₁B_{11,6},

B_{11,2}→b₂₂B_{11,7}|b₂₅B_{11,7},

B_{11,2}→b₂₈B_{11,8},

B_{11,2}→b₃B_{11,9},

B_{11,3}→b₂B_{11,9}|b₃B_{11,9},

B_{11,4}→b₂B_{11,9}|b₃B_{11,9}|b₁₄B_{11,9}|b₁₅B_{11,9},

B_{11,4}→b₁₁B_{11,10},

B_{11,5}→b₂₄B₁₂,

B_{11,5}→b₂₄B_{11,11},

B_{11,6}→b₂₄B_{11,12}|b₂₅B_{11,12}|b₂₆B_{11,12},

B_{11,6}→b₂₅B_{11,11}|b₂₆B_{11,11},

B_{11,7}→b₂₆B_{11,12},

B_{11,8}→b₂₅B_{11,12}|b₂₆B_{11,12},

B_{11,8}→b₂₅B_{11,11}|b₂₆B_{11,11},

B_{11,9}→b₂₄B_{11,12}|b₂₅B_{11,12},

B_{11,9}→b₂₄B_{11,11}|b₂₅B_{11,11},

B_{11,10}→b₂₅B_{11,12},

B_{11,10}→b₂₅B_{11,11},

B_{11,11}→iB_{11,12}|iB_{11,12}|eB_{11,12}|oB_{11,12},

B_{11,12}→b₃|b₄|b₁₁|b₁₂|b₁₅|b₁₆|b₂₃|b₂₅|b₂₆|b₂₈}

With respect to a Tibetan spelling structure 12:

Tibetan spelling formal grammar G_{12:} the spelling formal grammar G₁₂ of the Tibetan prefixes, the superfixes, the roots, the subfixes, the vowel symbols and the suffixes is a quadruple (T₁₂, V₁₂, S₁₂, P₁₂), wherein:

(1) terminal symbol

T₁₂=T_{B}∪Tₒ, wherein:

T_{B}={b₁,b₃,b₄,b₁₁,b₁₂,b₁₅,b₁₆,b₂₃,b₂₄,b₂₅,b₂₆,b₂₈}, the elements thereof correspond to the Tibetan consonant characters; and Tₒ={i,u,e,o}, the elements thereof correspond to the Tibetan vowel characters;

(2) non-tell final symbol set

V₁₂={S₁₂,B_{12,1},B_{12,2},B_{12,3}B_{12,4},B_{12,5},B_{12,6},B_{12,7}};

(3) S₁₂ is a non-terminal symbol in V₁₂ and is the start symbol; and

(4) the production set of the grammar G₁₂ is: P₁₂={

S₁₂→b₁₅B_{12,1},

B_{12,1}→b₂₈B_{12,2},

B_{12,1}→b₂₅B_{12,3},

B_{12,2}→b₁B_{12,4}|b₃B_{12,4},

B_{12,3}→b₁B_{12,5}|b₃B_{12,5},

B_{12,4}→b₂₄B_{12,7}|b₂₅B_{12,7},

B_{12,4}→b₂₄B_{12,6}|b₂₅B_{12,6},

B_{12,5}→b₂₄B_{12,7},

B_{12,5}→b₂₄B_{12,6},

B_{12,6}→iB_{12,7}|uB_{12,7}|eB_{12,7}|oB_{12,7},

B_{12,7}→b₃|b₄|b₁₁|b₁₂|b₁₅|b₁₆|b₂₃|b₂₅|b₂₆|b₂₈}

With respect to a Tibetan spelling structure 13:

Tibetan spelling formal grammar G₁₃ the spelling formal grammar G₁₃ of the Tibetan prefixes, the roots, the vowel symbols, the suffixes and the postfixes is a quadruple (T₁₃, V₁₃, S₁₃, P₁₃), wherein:

(1) terminal symbol

T₁₃=T_{B}∪Tₒ, wherein:

T_{B}={b₁,b₂,b₃,b₄,b₅,b₆,b₇,b₈,b₉,b₁₀,b₁₁,b₁₂,b₁₃,b₁₄,b₁₅,b₁₀,b₁₇,b₁₈,b₁₉,b₂₁,b₂₂,b₂₃,b₂₄,b₂₅,b₂₆,b₂₇,b₂₈}, the elements thereof correspond to the Tibetan consonant characters; and Tₒ={i,u,e,o}, the elements thereof correspond to the Tibetan vowel characters;

(2) non-terminal symbol set

V₁₃={S₁₃,B_{13,1},B_{13,2},B_{13,3}B_{13,4},B_{13,5},B_{13,6},B_{13,7},B_{13,8},B_{13,9}};

(3) S₁₃ is a non-terminal symbol in V₁₃ and is the start symbol; and

(4) the production set of the grammar G₁₃ is: P₁₃={

S₁₃→b₃B_{13,1}|b₁₁B_{13,2}|b₁₅B_{13,3}|b₁₆B_{13,4}|b₂₃B_{13,5},

B_{13,1}→b₅B_{13,6}|b₈B_{13,6}|b₉B_{13,6}|b₁₁B_{13,6}|b₁₂B_{13,6}|b₁₇B_{13,6}|b₂₁B_{13,6}|b₂₂B_{13,6}|b₂₄B_{13,6}|b₂₇B_{13,6}|b₂₈B_{13,6},

B_{13,2}→b₁B_{13,6}|b₃B_{13,6}|b₄B_{13,6}|b₁₃B_{13,6}|b₁₅B_{13,6}|b₁₆B_{13,6},

B_{13,3}→b₁B_{13,6}|b₃B_{13,6}|b₅B_{13,6}|b₉B_{13,6}|b₁₁B_{13,6}|b₁₇B_{13,6}|b₂₁B_{13,6}|b₂₂B_{13,6}|b₂₇B_{13,6}|b₂₈B_{13,6},

B_{13,4}→b₂B_{13,6}|b₃B_{13,6}|b₄B_{13,6}|b₆B_{13,6}|b₇B_{13,6}|b₈B_{13,6}|b₁₀B_{13,6}|b₁₁B_{13,6}|b₁₂B_{13,6}|b₁₈B_{13,6}|b₁₉B_{13,6},

B_{13,5}→b₂B_{13,6}|b₃B_{13,6}|b₆B_{13,6}|b₇B_{13,6}|b₁₀B_{13,6}|b₁₁B_{13,6}|b₁₄B_{13,6}|b₁₅B_{13,6}|b₁₈B_{13,6}|b₁₉B_{13,6},

B_{13,6}→iB_{13,7}|uB_{13,7}|eB_{13,7} oB_{13,7},

B_{13,6}→b₃B_{13,8}|b₄B_{13,8}|b₁₅B_{13,8}|b₁₆B_{13,8},

B_{13,6}→b₁₂B_{13,9}|b₂₅B_{13,9}|b₂₆B_{13,9},

B_{13,7}→b₃B_{13,8} b₄B_{13,8}|b₁₅B_{13,8} b₁₆B_{13,8},

B_{13,7}→b₁₂B_{13,9}|b₂₅B_{13,9}|b₂₆B_{13,9},

B_{13,8}→b₂₈,

B_{13,9}→b₁₁}

With respect to a Tibetan spelling structure 14:

Tibetan spelling formal grammar G_{14:} the spelling formal grammar G₁₄ of the Tibetan prefixes, the superfixes, the roots, the vowel symbols, the suffixes and the postfixes is a quadruple (T₁₄, V₁₄, S₁₄, P₁₄), wherein:

(1) terminal symbol

T₁₄=T_{B}∪Tₒ, wherein:

T_{B}={b₁,b₃,b₄,b₁₁,b₁₂,b₁₃,b₁₅,b₁₀,b₁₇,b₂₀,b₂₄,b₂₅,b₂₆,b₂₈}, the elements thereof correspond to the Tibetan consonant characters; and Tₒ={i,u,e,o}, the elements thereof correspond to the Tibetan vowel characters;

(2) non-terminal symbol set

V₁₄={S₁₄,B_{14,1},B_{14,2},B_{14,3},B_{14,4},B_{14,5},B_{14,6},B_{14,7},B_{14,8}};

(3) S₁₄ is a non-terminal symbol in V₁₄ and is the start symbol; and

(4) the production set of the grammar G₁₄ is: P₁₄={

S₁₄→b₁₅B_{14,1},

B_{14,1}→b₂₈B_{14,2}|b₂₆B_{14,3}|b₂₅B_{14,4},

B_{14,2}→b₁B_{14,5}|b₃B_{14,5}|b₄B_{14,5}|b₈B_{14,5}|b₉B_{14,5}|b₁₄B_{14,5}|b₁₂B_{14,5}|b₁₇B_{14,5},

B_{14,3}→b₉B_{14,5}|b₁₁B_{14,5},

B_{14,4}→b₁B_{14,5}|b₃B_{14,5}|b₄B_{14,5}|b₇B_{14,5}|b₈B_{14,5}|b₉B_{14,5}|b₁₁B_{14,5}|b₁₂B_{14,5}|b₁₇B_{14,5}|b₁₉B_{14,5},

B_{14,5}→b₃B_{14,6}|uB_{14,6}|eB_{14,6}|oB_{14,6},

B_{14,5}→b₃B_{14,7}|b₄B_{14,7}|b₁₅B_{14,7}|b₁₆B_{14,7},

B_{14,5}→b₁₂B_{14,8}|b₂₅B_{14,8}|b₂₆B_{14,8},

B_{14,6}→b₃B_{14,7}|b₄B_{14,7}|b₁₅B_{14,7}|b₁₆B_{14,7},

B_{14,6}→b₁₂B_{14,8}|b₂₅B_{14,8}|b₂₆B_{14,8},

B_{14,7}→b₂₈,

B_{14,8}→b₁₁}

With respect to a Tibetan spelling structure 15:

Tibetan spelling formal grammar G_{15:} the spelling formal grammar G₁₅ of the Tibetan prefixes, the roots, the subfixes, the vowel symbols, the suffixes and the postfixes is a quadruple (T₁₅, V₁₅, S₁₅, P₁₅), wherein:

(1) terminal symbol

T₅=T_{B}∪Tₒ, wherein:

T_{B}={b₁,b₂,b₃,b₄,b₁₁,b₁₂,b₁₃,b₁₄,b₁₅,b₁₆,b₂₂,b₂₃,b₂₄,b₂₅,b₂₆,b₂₈}, the elements thereof correspond to the Tibetan consonant characters; and Tₒ={i,u,e,o}, the elements thereof correspond to the Tibetan vowel characters;

(2) non-terminal symbol set

V₁₅={S₁₅,B_{15,1},B_{15,2},B_{15,3},B_{15,4},B_{15,5},B_{15,6},B_{15,7},B_{15,8},B_{15,9},B_{15,10},B_{15,11},B_{15,12},B_{15,13},B_{15,14}};

(3) S₁₅ is a non-terminal symbol in V₁₅ and is the start symbol; and

(4) the production set of the grammar G₁₅ is: P₁₅={

S₁₅→b₁₁B_{15,1} b₁₅B_{15,2}|b₁₆B_{15,3}|b₂₃B_{15,4},

B_{15,1}→b₁₆B_{15,5},

B_{15,1}→b₁B_{15,9}|b₃B_{15,9}|b₁₃B_{15,9}|b₁₅B_{15,9},

B_{15,2}→b₁B_{15,6},

B_{15,2}→b₂₂B_{15,7}|b₂₅B_{15,7},

B_{15,2}→b₂₈B_{15,8},

B_{15,2}→b₃B_{15,9},

B_{15,3}→b₂B_{15,9}|b₃B_{15,9},

B_{15,4}→b₂B_{15,9}|b₃B_{15,9}|b₁₄B_{15,9}|b₁₅B_{15,9},

B_{15,4}→b₁₁B_{15,10},

B_{15,5}→b₂₄B_{15,11},

B_{15,6}→b₂₄B_{15,11}|b₂₅B_{15,11}|b₂₆B_{15,11},

B_{15,7}→b₂₆B_{15,11},

B_{15,8}→b₂₅B_{15,11}|b₂₆B_{15,11},

B_{15,9}→b₂₄B_{15,11}|b₂₅B_{15,11},

B_{15,10}→b₂₅B_{15,11},

B_{15,11}→iB_{15,12}|uB_{15,12}|eB_{15,12}|oB_{15,12},

B_{15,11}→b₃B_{15,13}|b₄B_{15,13}|b₁₅B_{15,13}|b₁₆B_{15,13},

B_{15,11}→b₁₂B_{15,4}|b₂₅B_{15,14}|b₂₆B_{15,14},

B_{15,12}→b₃B_{15,13}|b₄B_{15,13}|b₁₅B_{15,13}|b₁₆B_{15,13},

B_{15,12}→b₁₂B_{15,14}|b₂₅B_{15,14}|b₂₆B_{15,14},

B_{15,13}→b₂₈,

B_{15,14}→b₁₁}

With respect to a Tibetan spelling structure 16:

Tibetan spelling formal grammar G₁₆ the Tibetan character spelling grammar G₁₆ of the Tibetan prefixes, the superfixes, the roots, the subfixes, the vowel symbols, the suffixes and the postfixes is a quadruple (T₁₆, V₁₆, S₁₆, P₁₆), wherein:

(1) terminal symbol

T₁₆=T_{B}∪Tₒ, wherein:

T_{B}={b₁,b₃,b₄,b₁₁,b₁₂,b₁₅,b₁₆,b₂₄,b₂₅,b₂₆,b₂₈}, the elements thereof correspond to the Tibetan consonant characters; and Tₒ={i,u,e,o}, the elements thereof correspond to the Tibetan vowel characters;

(2) non-terminal symbol set

V₁₆={S₁₆,B_{16,1},B_{16,2},B_{16,3},B_{10,4},B_{16,5},B_{16,6},B_{16,7},B_{16,8},B_{16,9}};

(3) S₁₆ is a non-terminal symbol in V₁₆ and is the start symbol; and

(4) the production set of the grammar G₁₆ is: P₁₆={

S₁₆→b₁₅B_{16,1},

B_{16,1}→b₂₈B_{16,2},

B_{16,1}→b₂₅B_{16,3},

B_{16,2}→b₁B_{16,4}|b₃B_{16,4},

B_{16,3}→b₁B_{16,5}|b₃B_{16,5},

B_{16,4}→b₂₄B_{16,6}|b₂₅B_{16,6},

B_{16,5}→b₂₄B_{16,6},

B_{16,6}→iB_{16,7}|uB_{16,7}|eB_{16,7}|oB_{16,7},

B_{16,6}→b₃B_{16,8}|b₄B_{16,8}|b₁₅B_{16,8}|b₁₆B_{16,8},

B_{16,6}→b₁₂B_{16,9}|b₂₅B_{16,9}|b₂₆B_{16,9},

B_{16,7}→b₃B_{16,8}|b₄B_{16,8}|b₁₅B_{16,8}|b₁₆B_{16,8},

B_{16,7}→b₁₂B_{16,9}|b₂₅B_{16,9}|b₂₆B_{16,9},

B_{16,8}→b₂₈,

B_{16,9}→b₁₁}

With respect to a Tibetan spelling structure 17:

Tibetan spelling formal grammar G_{17:} the spelling formal grammar G₁₇ of the Tibetan roots, the vowel symbols and the suffixes is a quadruple (T₁₇, V₁₇, S₁₇, P₁₇), wherein:

(1) terminal symbol

T₁₇=T_{B}∪Tₒ, wherein:

T_{B}={b₁, b₂, b₃, b₄, b₅, . . . , b₃₀}, the elements thereof correspond to the Tibetan consonant characters; and Tₒ={i,u,e,o}, the elements thereof correspond to the Tibetan vowel characters;

(2) non-terminal symbol set

V₁₇={S₁₇,B_{17,1}B_{17,2}};

(3) S₁₇ is a non-terminal symbol in V₁₇ and is the start symbol; and

(4) the production set of the grammar G₁₇ is: P₁₇={

S₁₇→b₁B_{17,1}|b₂B_{17,1}|b₃B_{17,1}|b₄B_{17,1}|b₅B_{17,1}| . . . |b₃₀B_{17,1},

S₁₇→b₁B_{17,2}|b₂B_{17,2}|b₃B_{17,2}|b₄B_{17,2}|b₅B_{17,2}|b₃₀B_{17,2},

B_{17,1}→iB_{17,2}|uB_{17,2}|eB_{17,2}|oB_{17,2},

B_{17,2}→b₃|b₄|b₁₁|b₁₂|b₁₅|b₁₆|b₂₃|b₂₅|b₂₆|b₂₈}

With respect to a Tibetan spelling structure 18:

Tibetan spelling formal grammar G₁₈; the spelling formal grammar G₁₈ of the Tibetan superfixes, the roots, the vowel symbols and the suffixes is a quadruple (T₁₈,V₁₈, S₁₈, P₁₈), wherein:

(1) terminal symbol

T₁₈=T_{B}∪Tₒ, wherein:

T_{B}={b₁,b₃,b₄,b₅,b₇,b₈,b₉,b₁₁,b₁₂,b₁₃,b₁₅,b₁₆,b₁₇,b₁₉,b₂₃,b₂₅,b₂₆,b₂₈,b₂₉}, the elements thereof correspond to the Tibetan consonant characters; and Tₒ={i,u,e,o}, the elements thereof correspond to the Tibetan vowel characters;

(2) non-terminal symbol set

V₁₈={S₁₈,B_{18,1},B_{18,2},B_{18,3},B_{18,4},B_{18,5}};

(3) S₁₈ is a non-terminal symbol in V₁₈ and is the start symbol; and

(4) the production set of the grammar G₁₈ is: P₁₈={

S₁₈→b₂₅B_{18,1}|b₂₆B_{18,2}|b₂₈B_{18,3},

B_{18,1}→b₁B_{18,5}|b₃B_{18,5}|b₄B_{18,5}|b₇B_{18,5}|b₈B_{18,5}|b₉B_{18,5}|b₁₁B_{18,5}|b₁₂B_{18,5}|b₁₅B_{18,5}|b₁₆B_{18,5}|b₁₇B_{18,5}|b₁₉B_{18,5},

B_{18,1}→b₁B_{18,4}|b₃B_{18,4}|b₄B_{18,4}|b₇B_{18,4}|b₈B_{18,4}|b₉B_{18,4}|b₁₁B_{18,4}|b₁₂B_{18,4}|b₁₅B_{18,4}|b₁₆B_{18,4}|b₁₇B_{18,4}|b₁₉B_{18,4},

B_{18,2}→b₁B_{18,5}|b₃B_{18,5}|b₄B_{18,5}|b₅B_{18,5}|b₇B_{18,5}|b₉B_{18,5}|b₁₁B_{18,5}|b₁₃B_{18,5}|b₁₅B_{18,5}|b₂₉B_{18,5},

B_{18,2}→b₁B_{18,4}|b₃B_{18,4}|b₄B_{18,4}|b₅B_{18,4}|b₇B_{18,4}|b₉B_{18,4}|b₁₁B_{18,4}|b₁₃B_{18,4}|b₁₅B_{18,4}|b₂₉B_{18,4},

B_{18,3}→b₁B_{18,5}|b₃B_{18,5}|b₄B_{18,5}|b₈B_{18,5}|b₉B_{18,5}|b₁₁B_{18,5}|b₁₂B_{18,5}|b₁₃B_{18,5}|b₁₅B_{18,5}|b₁₆B_{18,5}|b₁₇B_{18,5},

B_{18,3}→b₁B_{18,4}|b₃B_{18,4}|b₄B_{18,4}|b₈B_{18,4}|b₉B_{18,4}|b₁₁B_{18,4}|b₁₂B_{18,4}|b₁₃B_{18,4}|b₁₅B_{18,4}|b₁₆B_{18,4}|b₁₇B_{18,4},

B_{18,4}→iB_{18,5}|uB_{18,5}|eB_{18,5}|oB_{18,5},

B_{18,5}→b₃|b₄|b₁₁|b₁₂|b₁₅|b₁₆|b₂₃|b₂₅|b₂₆|b₂₈}

With respect to a Tibetan spelling structure 19:

Tibetan spelling formal grammar G_{19:} the spelling formal grammar G₁₉ of the Tibetan roots, the subfixes, the vowel symbols and the suffixes is a quadruple (T₆, V₆, S₆, P₆), wherein:

(1) terminal symbol

T₁₉=T_{B}∪Tₒ, wherein:

T_{B}={b₁,b₂,b₃,b₄,b₈,b₉,b₁₀,b₁₁,b₁₂,b₁₃,b₁₄,b₁₅,b₁₆,b₁₈,b₂₀,b₂₁,b₂₂,b₂₃,b₂₄,b₂₅,b₂₆,b₂₇,b₂₈,b₂₉}, the elements thereof correspond to the Tibetan consonant characters; and Tₒ={i,u,e,o}, the elements thereof correspond to the Tibetan vowel characters;

(2) non-terminal symbol set

V₁₉={S₁₉,B_{19,1},B_{19,2},B₁₉,B_{19,4},B_{19,5},B_{19,6},B_{19,7},B_{19,s},B_{19,9},B_{19,10},B_{19,11}};

(3) S₁₉ is a non-terminal symbol in V₁₉ and is the start symbol; and

(4) the production set of the grammar G₁₉ is: P₁₉={

S₁₉→b₁B_{19,1}|b₃B_{19,1},

S₁₉→b₂B_{19,21}

S₁₉→b₁₁B_{19,3}|b₂₉B_{19,3},

S₁₉→b₈B_{19,4}|b₁₈B_{19,4}|b₂₁B_{19,4}|b₂₆B_{19,4}|b₂₇B_{19,4},

S₁₉→b₉B_{19,5}|b₁₀B_{19,5},

S₁₉→b₁₃B_{19,6}|b₁₄B_{19,6}|b₁₆B_{19,6},

S₁₉→b₂₂B_{19,7}|b₂₅B_{19,7},

S₁₉→b₂₈B_{19,8},

S₁₉→b₁₅B_{19,9},

B_{19,1}→b₂₀B_{19,11}|b₂₄B_{19,11}|b₂₅B_{19,11}|b₂₆B_{19,11},

B_{19,1}→b₂₀B_{19,10}|b₂₄B_{19,10}|b₂₅B_{19,10}|b₂₆B_{19,10},

B_{19,2}→b₂₀B_{19,11}|b₂₄B_{19,11}|b₂₅B_{19,11},

B_{19,2}→b₂₀B_{19,10}|b₂₄B_{19,10}|b₂₅B_{19,10},

B_{19,3}→b₂₀B_{19,11}|b₂₅B_{19,11},

B_{19,3}→b₂₀B_{19,10}|b₂₅B_{19,10},

B_{19,4}→b₂₀B_{19,11},

B_{19,4}→b₂₀B_{19,10},

B_{19,5}→b₂₅B_{19,11},

B_{19,5}→b₂₅B_{19,10},

B_{19,6}→b₂₄B_{19,11}|b₂₅B_{19,11},

B_{19,6}→b₂₄B_{19,10}|b₂₅B_{19,10},

B_{19,7}→b₂₀B_{19,11}|b₂₆B_{19,11},

B_{19,7}→b₂₀B_{19,10}|b₂₆B_{19,10},

B_{19,8}→b₂₅B_{19,11}|b₂₆B_{19,11},

B_{19,8}→b₂₅B_{19,10}|b₂₆B_{19,10},

B_{19,9}→b₂₄B_{19,11}|b₂₅B_{19,11}|b₂₆B_{19,11},

B_{19,9}→b₂₄B_{19,10} b₂₅B_{19,10}|b₂₆B_{19,10},

B_{19,10}→iB_{19,11}|uB_{19,11}|eB_{19,11}|oB_{19,11},

B_{19,11}→b₃|b₄|b₁₁|b₁₂|b₁₅|b₁₆|b₂₃|b₂₅|b₂₆|b₂₈}

With respect to a Tibetan spelling structure 20:

Tibetan spelling formal grammar G₂₀ the spelling formal grammar G₂₀ of the superfixes, the Tibetan roots, the subfixes, the vowel symbols and the suffixes is a quadruple (T₂₀, V₂₀, S₂₀, P₂₀), wherein:

(1) terminal symbol

T₂₀=T_{B}∪Tₒ, wherein:

T_{B}={b₁,b₃,b₄,b₁₁,b₁₂,b₁₃,b₁₅,b₁₆,b₁₇,b₂₀,b₂₃,b₂₄,b₂₅,b₂₆,b₂₈}, the elements thereof correspond to the Tibetan consonant characters; and Tₒ={i,u,e,o}, the elements thereof correspond to the Tibetan vowel characters;

(2) non-terminal symbol set

V₂₀={S₂₀,B_{20,1},B_{20,2},B_{20,3},B_{20,4},B_{20,5},B_{20,6},B_{20,7},B_{20,8}};

(3) S₂₀ is a non-terminal symbol in V₂₀ and is the start symbol; and

(4) the production set of the grammar G₂₀ is: P₂₀={

S₂₀→b₂₅B_{20,1},

S₂₀→b₂₈B_{20,2},

B_{20,1}→b₁B_{20,3}|b₃B_{20,3}|b₁₆B_{20,3},

B_{20,1}→b₁₇B_{20,4},

B_{20,2}→b₁B_{20,5}|b₃B_{20,5}|b₁₃B_{20,5}|b₁₅B_{20,5}|b₁₆B_{20,5},

B_{20,2}→b₁₂B_{20,6},

B_{20,3}→b₂₄B_{20,8},

B_{20,3}→b₂₄B_{20,7},

B_{20,4}→b₂₀B_{20,8},

B_{20,4}→b₂₀B_{20,7},

B_{20,5}→b₂₄B_{20,8}|b₂₅B_{20,8},

B_{20,5}→b₂₄B_{20,7}|b₂₅B_{20,7},

B_{20,6}→b₂₅B_{20,8},

B_{20,6}→|b₂₅B_{20,7},

B_{20,7}→iB_{20,8}|uB_{20,8}|eB_{20,8}|oB_{20,8},

B_{20,8}→b₃|b₄|b₁₁|b₁₂|b₁₅|b₁₆|b₂₃|b₂₅|b₂₆|b₂₈}

With respect to a Tibetan spelling structure 21:

Tibetan spelling formal grammar G_{21:} the spelling formal grammar G₂₁ of the Tibetan roots, the vowel symbols, the suffixes and the postfixes is a quadruple (T₂₁, V₂₁, S₂₁, P₂₁), wherein:

(1) terminal symbol

T₂₁=T_{B}∪Tₒ, wherein:

T_{B}={b₁, b₂, b₃, b₄, b₅, . . . , b₃₀}, the elements thereof correspond to the Tibetan consonant characters; and Tₒ={i,u,e,o}, the elements thereof correspond to the Tibetan vowel characters;

(2) non-terminal symbol set

V₂₁={S₂₁,B_{21,1},B_{21,2},B_{21,3},B_{21,4},B_{21,5},B_{21,6},B_{21,7}};

(3) S₂₁ is a non-terminal symbol in V₂₁ and is the start symbol; and

(4) the production set of the grammar G₂₁ is: P₂₁={

S₂₁→b₁B_{21,1}|b₂B_{21,1}| . . . |b₁₀B_{21,1}|b₁₂B_{21,1}|b₁₃B_{21,1}|b₂₂B_{21,1}|b₂₄B_{21,1}|b₂₅B_{21,1}| . . . |b₃₀B_{21,1},

S₂₁→b₁B_{21,2},

S₂₁→|b₂₃B_{21,3},

B_{21,1}→iB_{21,4}|uB_{21,4}|eB_{21,4}|oB_{21,4},

B_{21,1}→b₃B_{21,7}|b₄B_{21,7}|b₁₅B_{21,7}|b₁₆B_{21,7},

B_{21,2}→iB_{21,5}|uB_{21,5}|eB_{21,5} oB_{21,55},

B_{21,3}→b₄B_{21,7}|b₁₆B_{21,7},

B_{21,3}→iB_{21,6}|uB_{21,6}|eB_{21,6}|oB_{21,6},

B_{21,4}→b₃B_{21,7}|b₄B_{21,7}|b₁₅B_{21,7}|b₁₆B_{21,7},

B_{21,5}→b₃B_{21,7}|b₄B_{21,7}|b₁₅B_{21,7}|b₁₆B_{21,7},

B_{21,6}→b₃B_{21,7}|b₄B_{21,7}|b₁₅B_{21,7}|b₁₆B_{21,7},

B_{21,7}→b₂₈}

With respect to a Tibetan spelling structure 22:

Tibetan spelling formal grammar G_{22:} the spelling formal grammar G₂₂ of the Tibetan superfixes, the roots, the vowel symbols, the suffixes and the postfixes is a quadruple (T₂₂, V₂₂, S₂₂, P₂₂), wherein:

(1) terminal symbol

T₂₂=T_{B}∪Tₒ, wherein:

T_{B}={b₁,b₃,b₄,b₅,b₇,b₈,b₉,b₁₁,b₁₂,b₁₃,b₁₅,b₁₆,b₁₇,b₁₉,b₂₅,b₂₆,b₂₈,b₂₉}, the elements thereof correspond to the Tibetan consonant characters; and Tₒ={i,u,e,o}, the elements thereof correspond to the Tibetan vowel characters;

(2) non-terminal symbol set

V₂₂={S₂₂,B_{22,1},B_{22,2},B_{22,3},B_{22,4},B_{22,5}};

(3) S₂₂ is a non-terminal symbol in V₂₂ and is the start symbol; and

(4) the production set of the grammar G₂₂ is: P₂₂={

S₂₂→b₂₅B_{22,1}|b₂₆B_{22,2}|b₂₈B_{22,3},

B_{22,1}→b₁B_{22,4}|b₃B_{22,4}|b₄B_{22,4}|b₇B_{22,4}|b₈B_{22,4}|b₉B_{22,4}|b₁₁B_{22,4}|b₁₂B_{22,4}|b₁₅B_{22,4}|b₁₆B_{22,4}|b₁₇B_{22,4}|b₁₉B_{22,4},

B_{22,2}→b₁B_{22,4}|b₃B_{22,4}|b₄B_{22,4}|b₅B_{22,4}|b₇B_{22,4}|b₉B_{22,4}|b₁₁B_{22,4}|b₁₃B_{22,4}|b₁₅B_{22,4}|b₂₉B_{22,4},

B_{22,3}→b₁B_{22,4}|b₃B_{22,4} b₄B_{22,4}|b₈B_{22,4}|b₉B_{22,4}|b₁₁B_{22,4} b₁₂B_{22,4}|b₁₃B_{22,4}|b₁₅B_{22,4}|b₁₆B_{22,4}|b₁₇B_{22,4},

B_{22,4}→iB_{22,7}|uB_{22,7}|eB_{22,7}|oB_{22,7},

B_{22,4}→b₁₂B_{22,5}|b₂₅B_{22,5}|b₂₆B_{22,5},

B_{22,4}→b₃B_{22,6}|b₄B_{22,6}|b₁₅B_{22,6}|b₁₆B_{22,6},

B_{22,7}→b₁₂B_{22,5}|b₂₅B_{22,5}|b₂₆B_{22,5},

B_{22,7}→b₃B_{22,6}|b₄B_{22,6}|b₁₅B_{22,6}|b₁₆B_{22,6},

B_{22,5}→b₁₁,

B_{22,6}→b₁₈}

With respect to a Tibetan spelling structure 23:

Tibetan spelling formal grammar G_{23:} the Tibetan character spelling grammar G₂₃ of the Tibetan roots, the subfixes, the vowel symbols, the suffixes and the postfixes is a quadruple (T₂₃, V_{23, 523}, P₂₃), wherein:

(1) terminal symbol

T₂₃=T_{B}∪Tₒ, wherein:

T_{B}={b₁,b₂,b₃,b₄,b₈,b₉,b₁₀,b₁₁,b₁₂,b₁₃,b₁₄,b₁₅,b₁₆,b₁₈,b₂₀,b₂₁,b₂₂,b₂₄,b₂₅,b₂₆,b₂₇,b₂₈,b₂₉}, the elements thereof correspond to the Tibetan consonant characters; and Tₒ={i,u,e,o}, the elements thereof correspond to the Tibetan vowel characters;

(2) non-terminal symbol set

V₂₃={S₂₃,B_{23,1},B_{23,2},B_{23,3},B_{23,4},B_{23,5},B_{23,6},B_{23,7},B_{23,8},B_{23,9},B_{23,10},B_{23,11},B_{23,12},B_{23,13}};

(3) S₂₃ is a non-terminal symbol in V₂₃ and is the start symbol; and

(4) the production set of the grammar G₂₃ is: P₂₃={

S₂₃→b₁B_{23,1}|b₃B_{23,1},

S₂₃→b₂B_{23,2},

S₂₃→b₁₁B_{23,3}|b₂₉B_{23,3},

S₂₃→b₈B_{23,4}|b₁₈B_{23,4}|b₂₁B_{23,4}|b₂₆B_{23,4}|b₂₇B_{23,4},

S₂₃→b₉B_{23,5}|b₁₀B_{23,5},

S₂₃→b₁₃B_{23,6}|b₁₄B_{23,6}|b₁₆B_{23,6},

S₂₃→b₂₂B_{23,7}|b₂₅B_{23,7},

S₂₃→b₂₈B_{23,8},

S₂₃→b₁₅B_{23,9},

B_{23,1}→b₂₀B_{23,10}|b₂₄B_{23,10}|b₂₅B_{23,10}|b₂₆B_{23,10},

B_{23,2}→b₂₀B_{23,10}|b₂₄B_{23,10}|b₂₅B_{23,10},

B_{23,3}→b₂₀B_{23,10}|b₂₅B_{23,10},

B_{23,4}→b₂₀B_{23,10},

B_{23,5}→b₂₅B_{23,10},

B_{23,6}→b₂₄B_{23,10}|b₂₅B_{23,10},

B_{23,7}→b₂₀B_{23,10}|b₂₆B_{23,10},

B_{23,8}→b₂₅B_{23,10}|b₂₆B_{23,10},

B_{23,9}→b₂₄B_{23,10}|b₂₅B_{23,10}|b₂₆B_{23,10},

B_{23,10}→iB_{23,11}|uB_{23,11}|eB_{23,11}|oB_{23,11},

B_{23,10}→b₁₂B_{23,12}|b₂₅B_{23,12}|b₂₆B_{23,12},

B_{23,10}→b₃B_{23,13}|b₄B_{23,13}|b₁₅B_{23,13}|b₁₆B_{23,13},

B_{23,11}→b₁₂B_{23,12}|b₂₅B_{23,12}|b₂₆B_{23,12},

B_{23,11}→b₃B_{23,13}|b₄B_{23,13}|b₁₅B_{23,13}|b₁₆B_{23,13},

B_{23,12}→b₁₁,

B_{23,13}→b₁₈}

With respect to a Tibetan spelling structure 24:

Tibetan spelling formal grammar G_{24:} the spelling formal grammar G₂₄ of the Tibetan superfixes, the roots, the suffixes, the vowel symbols, the suffixes and the postfixes is a quadruple (T₂₄, V₂₄, S₂₄, P₂₄), wherein:

(1) terminal symbol

T₂₄=T_{B}∪Tₒ, wherein:

T_{B}={b₁,b₃,b₄,b₁₁,b₁₂,b₁₃,b₁₅,b₁₆,b₁₇,b₂₀,b₂₄,b₂₅,b₂₆,b₂₈}, the elements thereof correspond to the Tibetan consonant characters; and Tₒ={i,u,e,o}, the elements thereof correspond to the Tibetan vowel characters;

(2) non-terminal symbol set

V₂₄={S₂₄,B_{24,1},B_{24,2},B_{24,3},B_{24,4},B₂₄,B_{24,6},B_{24,7},B_{24,8},B_{24,9},B_{24,10}};

(3) S₂₄ is a non-terminal symbol in V₂₄ and is the start symbol; and

(4) the production set of the grammar G₂₄ is: P₂₄={

S₂₄→b₂₅B_{24,1};

S₂₄→b₂₈B_{24,2},

B_{24,1}→b₁B_{24,3}|b₃B_{24,3}|b₁₆B_{24,3},

B_{24,1}→b₁₇B_{24,4},

B_{24,2}→b₁B_{24,5}|b₃B_{24,5}|b₁₃B_{24,5}|b₁₅B_{24,5}|b₁₆B_{24,5},

B_{24,2}→b₁₂B_{24,6},

B_{24,3}→b₂₄B_{24,7},

B_{24,4}→b₂₀B_{24,7},

B_{24,5}→b₂₄B_{24,7}|b₂₅B_{24,7},

B_{24,6}|b₂₅B_{24,7},

B_{24,7}→iB_{24,8}|uB_{24,8}|eB_{24,8}|oB_{24,8},

B_{24,7}→b₁₂B_{24,9}|b₂₅B_{24,9}|b₂₆B_{24,9},

B_{24,7}→b₃B_{24,10}|b₄B_{24,10}|b₁₅B_{24,10}|b₁₆B_{24,10},

B_{24,8}→b₁₂B_{24,9}|b₂₅B_{24,9}|b₂₆B_{24,9},

B_{24,8}→b₃B_{24,10}|b₄B_{24,10}|b₁₅B_{24,10}|b₁₆B_{24,10},

B_{24,9}→b₁₁,

B_{24,10}→b₁₈}

With respect to a Tibetan spelling structure 25:

Tibetan spelling formal grammar G_{25:} the spelling formal grammar G₂₅ of the Tibetan roots, the subfixes and the subfixes is a quadruple (T₂₅, V₂₅, S₂₅, P₂₅), wherein:

(1) terminal symbol

T₂₅={b₃,b₁₁,b₁₄,b₂₀,b₂₄,b₂₅}, the elements thereof correspond to the Tibetan consonant characters;

(2) non-terminal symbol set

V₂₅={S₂₅,B_{25,1},B_{25,2},B_{25,3}};

(3) S₂₅ is a non-terminal symbol in V₂₅ and is the start symbol; and

(4) the production set of the grammar G₂₅ is: P₂₅={

S₂₅→b₃B_{25,1}|b₁₁B_{25,1},

S₂₅→b₁₄B_{25,2},

B_{25,1}→b₂₅B_{25,3},

B_{25,2}→b₂₄B_{25,3},

B_{25,3}→b₂₀}

With respect to a Tibetan spelling structure 26:

Tibetan spelling formal grammar G₂₆ the spelling formal grammar G₂₆ of the Tibetan consonant characters, the consonant characters and the vowel symbols is a quadruple (T₂₆, V₂₆, S₂₆, P₂₆), wherein:

(1) terminal symbol

T₂₆=T_{B}∪Tₒ, wherein:

T_{B}={b₁₄,b₂₉}, the elements thereof correspond to the Tibetan consonant characters; and Tₒ={i,u,e,o}, the elements thereof correspond to the Tibetan vowel characters;

(2) non-terminal symbol set

V₂₆={S₂₆,B_{26,1},B_{26,2}};

(3) S₂₆ is a non-terminal symbol in V₂₆ and is the start symbol; and

(4) the production set of the grammar G₂₆ is: P₂₆={

S₂₆→b₂₉B_{26,1},

B_{26,1}→b₁₄,

B_{26,1}→b₁₄B_{26,2},

B_{26,2}→i|u|e|o}

With respect to a Tibetan spelling structure 27:

Tibetan spelling formal grammar G_{27:} the spelling formal grammar G₂₇ of the Tibetan consonant characters, the consonant characters, the vowel symbols and the suffixes is a quadruple (T₂₇, V₂₇, S₂₇, P₂₇), wherein:

(1) terminal symbol

T₂₇=T_{B}∪Tₒ, wherein:

T_{B}={b₃,b₄,b₁₁,b₁₂,b₁₄,b₁₅,b₁₆,b₂₃,b₂₅,b₂₆,b₂₈,b₂₉}, the elements thereof correspond to the Tibetan consonant characters; and Tₒ={i,u,e,o}, the elements thereof correspond to the Tibetan vowel characters;

(2) non-terminal symbol set

V₂₇={S₂₇,B_{27,1},B_{27,2},B_{27,3};

(3) S₂₇ is a non-terminal symbol in V₂₇ and is the start symbol; and

(4) the production set of the grammar G₂₇ is: P₂₇={

S₂₇→b₂₉B_{27,1},

B_{27,1}→b₁₄B_{27,3},

B_{27,1}b₁₄B_{27,2},

B_{27,2}→iB_{27,3}|uB_{27,3}|eB_{27,3}|oB_{27,3},

B_{27,3}→b₃|b₄|b₁₁|b₁₂|b₁₅|b₁₆|b₂₃|b₂₅|b₂₆|b₂₈}

With respect to a Tibetan spelling structure 28:

Tibetan spelling formal grammar G_{28:} the simultaneous spelling formal grammar G₂₈ of the Tibetan roots and the vowel symbols, and of the Tibetan roots and the vowel symbols is a quadruple (T₂₈, V₂₈, S₂₈, P₂₈), wherein:

(1) terminal symbol

T₂₈=T_{B}∪Tₒ, wherein:

T_{B}={b₁, b₂, b₃, b₄, b₅, . . . , b₃₀}, the elements thereof correspond to the Tibetan consonant characters; and Tₒ={i,u,e,o}, the elements thereof correspond to the Tibetan vowel characters;

(2) non-terminal symbol set

V₂₈={S₂₈,B_{28,1},B_{28,2},B_{28,3}};

(3) S₂₈ is a non-terminal symbol in V₂₈ and is the start symbol; and

(4) the production set of the grammar G₂₈

S₂₈→b₁B_{28,1}|b₂B_{28,1}|b₃B_{28,1}|b₄B_{28,1}|b₅B_{28,1}| . . . |b₃₀B_{28,1},

B_{28,1}→iB_{28,2}|uB_{28,2}|eB_{28,2}|oB_{28,25},

B_{28,1}→b₂₃B_{28,3},B_{28,2}→b₂₃B_{28,3},

B_{28,3}→i|u|e|o}

With respect to a Tibetan spelling structure 29:

Tibetan spelling formal grammar G_{29:} the simultaneous spelling formal grammar G₂₉ of the Tibetan superfixes, the roots and the vowels, and of the roots and the vowel symbols is a quadruple (T₂₉, V₂₉, S₂₉, P₂₉), wherein:

(1) terminal symbol

T₂₉=T_{B}∪Tₒ, wherein:

T_{B}={b₁,b₃,b₄,b₅,b₇,b₈,b₉,b₁₁,b₁₂,b₁₃,b₁₅,b₁₆,b₁₇,b₁₉,b₂₃,b₂₅,b₂₀,b₂₈,b₂₉}, the elements thereof correspond to the Tibetan consonant characters; and Tₒ={i,u,e,o}, the elements thereof correspond to the Tibetan vowel characters;

(2) non-terminal symbol set

V₂₉={S₂₉,B_{29,1},B_{29,2},B_{29,3},B_{29,4}B_{29,5},B_{29,6}};

(3) S₂₉ is a non-terminal symbol in V₂₉ and is the start symbol; and

(4) the production set of the grammar G₂₉ is: P₂₉={

S₂₉→b₂₅B_{29,1}|b₂₆B_{29,2}|b₂₈B_{29,3},

B_{29,1}→b₁B_{29,4}|b₃B_{29,4}|b₄B_{29,4}|b₇B_{29,4}|b₈B_{29,4}|b₉B_{29,4}|b₁₁B_{29,4} b₁₂B_{29,4}|b₁₅B_{29,4}|b₁₆B_{29,4}|b₁₇B_{29,4}|b₁₉B_{29,4},

B_{29,2}→b₁B_{29,4}|b₃B_{29,4}|b₄B_{29,4}|b₅B_{29,4}|b₇B_{29,4}|b₉B_{29,4}|b₁₁B_{29,4}|b₁₃B_{29,4}|b₁₅B_{29,4}|b₂₉B_{29,4},

B_{29,3}→b₁B_{29,4}|b₃B_{29,4}|b₄B_{29,4}|b₈B_{29,4}|b₉B_{29,4}|b₁₁B_{29,4}|b₁₂B_{29,4}|b₁₃B_{29,4}|b₁₅B_{29,4}|b₁₆B_{29,4}|b₁₇B_{29,4},

B_{29,4}→iB_{29,5}|iB_{29,5}|eB_{29,5}|oB_{29,5},

B_{29,4}→b₂₃B_{29,6},

B_{29,5}→b₂₃B_{29,6},

B_{29,6}→i|u|e|o}

With respect to a Tibetan spelling structure 30:

Tibetan spelling formal grammar G_{30:} the simultaneous spelling formal grammar G₃₀ of the Tibetan roots, the subfixes and the vowel symbols, and of the roots and the vowel symbols is a quadruple (T₃₀, V₃₀, S₃₀, P₃₀), wherein:

(1) terminal symbol

T₃₀=T_{B}∪Tₒ, wherein:

T_{B}={b₁,b₂,b₃,b₈,b₉,b₁₀,b₁₁,b₁₃,b₁₄,b₁₅,b₁₆,b₁₈,b₂₀,b₂₁,b₂₂,b₂₃,b₂₄,b₂₅,b₂₆,b₂₇,b₂₈,b₂₉}, the elements thereof correspond to the Tibetan consonant characters; and Tₒ={i,u,e,o}, the elements thereof correspond to the Tibetan vowel characters;

(2) non-terminal symbol set

V₃₀={S₃₀,B_{30,1},B_{30,2},B_{30,3},B_{30,4},B_{30,5},B_{30,6},B_{30,7},B_{30,8},B_{30,9},B_{30,10},B_{30,11},B_{30,12}};

(3) S₃₀ is a non-terminal symbol in V₃₀ and is the start symbol; and

(4) the production set of the grammar G₃₀ is: P₃₀={

S₃₀→b₁B_{30,1}|b₃B_{30,1},

S₃₀→b₂B_{30,2},

S₃₀→b₁₁B_{30,3}|b₂₉B_{30,3},

S₃₀→b₈B_{30,4}|b₁B_{30,4}|b₂₁B_{30,4}|b₂₆B_{30,4}|b₂₇B_{30,4},

S₃₀→b₉B_{30,5}|b₁₀B_{30,5},

S₃₀→b₁₃B_{30,6}|b₁₄B_{30,6}|b₁₆B_{30,6},

S₃₀→b₂₂B_{30,7}|b₂₅B_{30,7},

S₃₀→b₂₈B_{30,8},

S₃₀→b₁₅B_{30,9},

B_{30,1}→b₂₀B_{30,10}|b₂₄B_{30,10}|b₂₅B_{30,10}|b₂₆B_{30,10},

B_{30,2}→b₂₀B_{30,10}|b₂₄B_{30,10}|b₂₅B_{30,10},

B_{30,3}→b₂₀B_{30,10}|b₂₅B_{30,10},

B_{30,4}→b₂₀B_{30,10},

B_{30,5}→b₂₅B_{30,10},

B_{30,6}→b₂₄B_{30,10}|b₂₅B_{30,10},

B_{30,7}→b₂₀B_{30,10}|b₂₆B_{30,10},

B_{30,8}→b₂₅B_{30,10}|b₂₆B_{30,10},

B_{30,9}→b₂₄B_{30,10}|b₂₅B_{30,10}|b₂₆B_{30,10},

B_{30,10}→iB_{30,11}|uB_{30,11}|eB_{30,11}|oB_{30,11},

B_{30,10}→b₂₃B_{30,12},

B_{30,11}→b₂₃B_{30,12},

B_{30,12}→i|u|e|o}

With respect to a Tibetan spelling structure 31:

Tibetan spelling formal grammar G_{31:} the simultaneous spelling formal grammar G₃₁ of the superfixes, the Tibetan roots, the subfixes and the vowel symbols, and of the roots and the vowel symbols is a quadruple (T₃₁, V₃₁, S₃₁, P₃₁), wherein:

(1) terminal symbol

T₃₁=T_{B}∪Tₒ, wherein:

T_{B}={b₁,b₃,b₁₂,b₁₃,b₁₅,b₁₆,b₁₇,b₂₀,b₂₃,b₂₄,b₂₅,b₂₈}, the elements thereof correspond to the Tibetan consonant characters; and Tₒ={i,u,e,o}, the elements thereof correspond to the Tibetan vowel characters;

(2) non-terminal symbol set

V₃₁={S₃₁,B_{31,1},B_{31,2},B_{31,3},B_{31,4},B_{31,5},B_{31,6},B_{31,7},B_{31,8},B_{31,9}};

(3) S₃₁ is a non-terminal symbol in V₃₁ and is the start symbol; and

(4) the production set of the grammar G₃₁ is: P₃₁={

S₃₁→b₂₅B_{31,1},

S₃₁→b₂₈B_{31,2},

B_{31,1}→b₁B_{31,3}|b₃B_{31,3}|b₁₆B_{31,3},

B_{31,1}→b₁₇B_{31,4},

B_{31,2}→b₁B_{31,5}|b₃B_{31,5}|b₁₃B_{31,5}|b₁₅B_{31,5}|b₁₆B_{31,5},

B_{31,2}→b₁₂B_{31,6},

B_{31,3}→b₂₄B_{31,7},

B_{31,4}→b₂₀B_{31,7},

B_{31,5}→b₂₄B_{31,7}|b₂₅B_{31,75},

B_{31,6}→b₂₅B_{31,7},

B_{31,7}→iB_{31,8}|uB_{31,8}|eB_{31,8}|oB_{31,8},

B_{31,7}→b₂₃B_{31,9},

B_{31,8}→b₂₃B_{31,9},

B_{31,9}*i|u|e|o}

With respect to a Tibetan spelling structure 32:

Tibetan spelling formal grammar G_{32:} the simultaneous spelling formal grammar G₃₂ of the Tibetan prefixes, the superfixes, the roots and the vowel symbols, and of the roots and the vowel symbols is a quadruple (T₃₂, V₃₂, S₃₂, P₃₂), wherein:

(1) terminal symbol

T₃₂=T_{B}∪Tₒ, wherein:

T_{B}={b₁,b₃,b₄,b₇,b₈,b₉,b₁₁,b₁₂,b₁₅,b₁₇,b₁₉,b₂₃,b₂₅,b₂₆,b₂₈}, the elements thereof correspond to the Tibetan consonant characters; and Tₒ{i,u,e,o}, the elements thereof correspond to the Tibetan vowel characters;

(2) non-terminal symbol set

V₃₂={S₃₂,B_{32,1},B_{32,2},B_{32,3},B_{32,4},B_{32,5},B_{32,6},B_{32,7}};

(3) S₃₂ is a non-terminal symbol in V₃₂ and is the start symbol; and

(4) the production set of the grammar G₃₂ is: P₃₂={

S₃₂→b₁₅B_{32,1},

B_{32,1}→b₂₈B_{32,2},

B_{32,1}→b₂₆B_{32,3},

B_{32,1}→b₂₅B_{32,4},

B_{32,2}→b₁B_{32,5}|b₃B_{32,5}|b₄B_{32,5}|b₈B_{32,5}|b₉B_{32,5}|b₁₁B_{32,5}|b₁₂B_{32,5}|b₁₇B_{32,5},

B_{32,3}→b₉B_{32,5}|b₁ B_{32,5},

B_{32,4}→b₁B_{32,5}|b₃B_{32,5}|b₄B_{32,5}|b₇B_{32,5}|b₈B_{32,5}|b₉B_{32,5}|b₁₁B_{32,5}|b₁₂B_{32,5}|b₁₇B_{32,5}|b₁₉B_{32,5},

B_{32,5}→iB_{32,6}|uB_{32,6}|eB_{32,6}|oB_{32,6},

B_{32,5}→b₂₃B_{32,7},

B_{32,6}→b₂₃B_{32,7},

B_{32,7}*i|u|e|o}

With respect to a Tibetan spelling structure 33:

Tibetan spelling formal grammar G_{33:} the simultaneous spelling formal grammar G₃₂ of the Tibetan prefixes, the roots, the subfixes and the vowel symbols, and of the roots and the vowel symbols is a quadruple (T₃₃, V₃₃, S₃₃, P₃₃), wherein:

(1) terminal symbol

T₃₃=T_{B}∪Tₒ, wherein:

T_{B}={b₁,b₂,b₃,b₁₁,b₁₃,b₁₄,b₁₅,b₁₆,b₂₂,b₂₃,b₂₄,b₂₅,b₂₆,b₂₈}, the elements thereof correspond to the Tibetan consonant characters; and Tₒ={i,u,e,o}, the elements thereof correspond to the Tibetan vowel characters;

(2) non-terminal symbol set

V₃₃={S₃₃,B_{33,1},B_{33,2},B_{33,31}B_{33,4},B_{33,5},B_{33,6},B_{33,7},B_{33,8},B_{33,9},B_{33,10},B_{33,11},B_{33,12},B_{33,13}}

(3) S₃₃ is a non-terminal symbol in V₃₃ and is the start symbol; and

(4) the production set of the grammar G₃₃ is: P₃₃={

S₃₃→b₁₁B_{33,1}|b₁₅B_{33,2}|b₁₆B_{33,3}|b₂₃B_{33,4},

B_{33,1}→b₁₆B_{33,5},

B_{33,1}→b₁B_{33,9}|b₃B_{33,9}|b₁₃B_{33,9}|b₁₅B_{33,9},

B_{33,2}→b₁B_{33,6},

B_{33,2}→b₂₂B_{33,7}|b₂₅B_{33,7},

B_{33,2}→b₂₈B_{33,8},

B_{33,2}→b₃B_{33,9},

B_{33,3}→b₂B_{33,9}|b₃B_{33,9},

B_{33,4}→b₂B_{33,9}|b₃B_{33,9}|b₁₄B_{33,9}|b₁₅B_{33,9},

B_{33,4}→b₁₁B_{33,10},

B_{33,5}→b₂₄B_{33,11},

B_{33,6}→b₂₄B_{33,11}|b₂₅B_{33,11}|b₂₆B_{33,11},

B_{33,7}→b₂₆B_{33,11},

B_{33,8}→b₂₅B_{33,11}|b₂₆B_{33,11},

B_{33,9}→b₂₄B_{33,11}|b₂₅B_{33,11},

B_{33,10}→b₂₅B_{33,11},

B_{33,11}→iB_{33,12}|uB_{33,12}|eB_{33,12}|oB_{33,12},

B_{33,11}→b₂₃B_{33,13},

B_{33,12}→b₂₃B_{33,13},

B_{33,13}→i|u|e|o}

With respect to a Tibetan spelling structure 34:

Tibetan spelling formal grammar G_{34:} the simultaneous spelling formal grammar G₃₄ of the Tibetan prefixes, the superfixes, the roots, the subfixes and the vowel symbols, and of the roots and the vowel symbols is a quadruple (T₃₄, V₃₄, S₃₄, P₃₄), wherein:

(1) terminal symbol

T₃₄=T_{B}∪Tₒ, wherein:

T_{B}={b₁,b₃,b₁₅,b₂₃,b₂₄,b₂₅,b₂₈}, the elements thereof correspond to the Tibetan consonant characters; and Tₒ={i,u,e,o}, the elements thereof correspond to the Tibetan vowel characters;

(2) non-terminal symbol set

V₃₄={S₃₄,B_{34,1},B_{34,2},B_{34,3},B_{34,4},B_{34,5},B_{34,6},B_{34,7},B_{34,8}};

(3) S₃₄ is a non-terminal symbol in V₃₄ and is the start symbol; and

(4) the production set of the grammar G₃₄ is: P₃₄={

S₃₄→b₁₅B_{34,1},

B_{34,1}→b₂₈B_{34,2},

B_{34,1}→b₂₅B_{34,3},

B_{34,2}→b₁B_{34,4}|b₃B_{34,4},

B_{34,3}→b₁B_{34,5}|b₃B_{34,5},

B_{34,4}→b₂₄B_{34,6}|b₂₅B_{34,6},

B_{34,5}→b₂₄B_{34,6},

B_{34,6}→iB_{34,7}|uB_{34,7}|eB_{34,7}|oB_{34,7},

B_{34,6}→b₂₃B_{34,8},

B_{34,7}→b₂₃B_{34,8},

B_{34,8}÷i|u|e|o}

With respect to a Tibetan spelling structure 35:

Tibetan spelling formal grammar G_{35:} the simultaneous spelling formal grammar G₃₅ of the Tibetan prefixes, the roots and the vowel symbols, and of the roots and the vowel symbols is a quadruple (T₃₅, V₃₅, S₃₅, P₃₅), wherein:

(1) terminal symbol

T₃₅=T_{B}∪Tₒ, wherein:

T_{B}={b₁,b₂,b₃,b₄,b₅,b₆,b₇,b₈,b₉,b₁₀,b₁₁,b₁₂,b₁₃,b₁₄,b₁₅,b₁₆,b₁₇,b₁₈,b₁₉,b₂₁,b₂₂,b₂₃,b₂₄,b₂₇,b₂₈}, the elements thereof correspond to the Tibetan consonant characters; and Tₒ={i,u,e,o}, the elements thereof correspond to the Tibetan vowel characters;

(2) non-terminal symbol set

V₃₅={S₃₅,B_{35,1},B_{35,2},B_{35,3},B_{35,4},B_{35,5},B_{35,6},B_{35,7},B_{35,8}};

(3) S₃₅ is a non-terminal symbol in V₃₅ and is the start symbol; and

(4) the production set of the grammar G₃₅ is: P₃₅={

S₃₅→b₃B_{35,1}|b₁₁B_{35,2}|b₁₅B_{35,3}|b₁₆B_{35,4}|b₂₃B_{35,5},

B_{35,1}→b₅B_{35,6}|b₈B_{35,6}|b₉B_{35,6}|b₁₁B_{35,6}|b₁₂B_{35,6}|b₁₇B_{35,6}|b₂₁B_{35,6}|b₂₂B_{35,6}|b₂₄B_{35,6}|b₂₇B_{35,6}|b₂₈B_{35,6},

B_{35,2}→b₁B_{35,6}|b₃B_{35,6}|b₄B_{35,6}|b₁₃B_{35,6}|b₁₅B_{35,6}|b₁₆B_{35,6},

B_{35,3}→b₁B_{35,6}|b₃B_{35,6}|b₅B_{35,6}|b₉B_{35,6}|b₁₁B_{35,6}|b₁₇B_{35,6}|b₂₁B_{35,6}|b₂₂B_{35,6}|b₂₇B_{35,6}|b₂₈B_{35,6},

B_{35,4}→b₂B_{35,6}|b₃B_{35,6}|b₄B_{35,6}|b₆B_{35,6}|b₇B_{35,6}|b₈B_{35,6}|b₁₀B_{35,6}|b₁₁B_{35,6}|b₁₂B_{35,6}|b₁₈B_{35,6}|b₁₉B_{35,6},

B_{35,5}→b₂B_{35,6}|b₃B_{35,6}|b₆B_{35,6}|b₇B_{35,6}|b₁₀B_{35,6}|b₁₁B_{35,6}|b₁₄B_{35,6}|b₁₅B_{35,6}|b₁₈B_{35,6}|b₁₉B_{35,6},

B_{35,6}→iB_{35,7}|uB_{35,7}|eB_{35,7} oB_{35,77},

B_{35,7}→b₂₃B_{35,8},

B_{35,8}→i|u|e|o}

With respect to a Tibetan spelling structure 36:

Tibetan spelling formal grammar G_{36:} the simultaneous spelling formal grammar G₃₆ of the Tibetan roots, the subfixes and the subfixes, and of the roots and the vowel symbols is a quadruple (T₃₆, V₃₆, S₃₆, P₃₆), wherein:

(1) terminal symbol

T₃₆=T_{B}∪Tₒ, wherein:

T₈={b₃,b₁₁,b₁₄,b₂₀,b₂₃,b₂₄,b₂₅}, the elements thereof correspond to the Tibetan consonant characters; and Tₒ={i,u,e,o}, the elements thereof correspond to the Tibetan vowel characters;

(2) non-terminal symbol set

V₃₆={S₃₆,B_{36,1},B_{36,2},B₃₆,B_{36,4},B_{36,5}};

(3) S₃₆ is a non-terminal symbol in V₃₆ and is the start symbol; and

(4) the production set of the grammar G₃₆ is: P₃₆={

S₃₆→b₃B_{36,1}|b₁₁B_{36,1},

S₃₆→b₁₄B_{36,2},

B_{36,1}→b₂₅B_{36,3},

B_{36,2}→b₂₄B_{36,3},

B_{36,3}→b₂₀B_{36,4},

B_{36,4}→b₂₃B_{36,5},

B_{36,5}→i|u|e|o}

With respect to a Tibetan spelling structure 37:

Tibetan spelling formal grammar G₃₇ the simultaneous spelling formal grammar G₃₇ of the Tibetan consonant characters, the consonant characters and the vowel symbols, and of the roots and the vowel symbols is a quadruple (T₃₇, V₃₇, S₃₇, P₃₇), wherein:

(1) terminal symbol

T₃₇=T_{B}∪Tₒ, wherein:

T_{B}={b₁₄,b₂₃,b₂₉}, the elements thereof correspond to the Tibetan consonant characters; and Tₒ={i,u,e,o}, the elements thereof correspond to the Tibetan vowel characters;

(2) non-terminal symbol set

V₃₇={S₃₇,B_{37,1},B_{37,2},B_{37,3},B_{37,4}};

(3) S₃₇ is a non-terminal symbol in V₃₇ and is the start symbol; and

(4) the production set of the grammar G₃₇ is: P₃₇={

S₃₇→b₂₉B_{37,1},

B_{37,1}→b₁₄B_{37,2},

B_{37,2}→iB_{37,3}|uB_{37,3}|eB_{37,3} oB_{37,3},

B_{37,2}→b₂₃B_{37,4},

B_{37,3}→b₂₃B_{37,4},

B_{37,4}→i|u|e|o}.

Step 303, a termination state identifier Eᵢ of the finite state automaton Mᵢ is acquired.

In the embodiment, the process of acquiring a newly added non-terminal symbol Eᵢ through the step 303 includes: judging whether the finite set Pᵢ of the production rules of the Tibetan spelling formal grammar Gᵢ contains a production rule B→x, wherein BεVᵢ, and xεTᵢ; and if so, acquiring Eᵢεδᵢ (B, x), wherein δᵢ (B, x)=φ.

In the embodiment, Eᵢ belongs to one of the non-terminal symbols.

Step 304, whether the finite set Pᵢ of the production rules of the Tibetan spelling formal grammar Gᵢ contains a production rule Sᵢ→λ is judged.

In the embodiment, if is determined that the finite set Pᵢ of the production rules of the Tibetan spelling formal grammar Gᵢ contains the production rule Sᵢ→λ in the step 304, step 307 is executed after step 305 is executed; and otherwise, step 306 is executed.

Step 305, Fᵢ with values of Sᵢ and Eᵢ is acquired.

Step 306, Fᵢ with a value Eᵢ is acquired.

Step 307, the finite state automaton Mᵢ is acquired according to Tᵢ, Vᵢ, Sᵢ and Fᵢ.

Step 308 to step 309, at least one Tibetan character is used as the input of the finite state automaton group, and whether the Tibetan text to be checked is correctly spelled is judged. The process is similar to the step 102 to the step 103 as shown in FIG. 1, and thus will not be repeated redundantly herein.

The present invention has the following beneficial effects: the Tibetan text to be checked is used as the input of the finite state automaton group to achieve Tibetan spelling check. As the finite state automaton group corresponds to the Tibetan spelling formal grammar, the technical solutions provided by the embodiment of the present invention can solve the problem in the prior art that when the spelling check is carried out by a model, as the application range of the model is relatively narrow, some Tibetan characters with special structures cannot be recognized.

### Fourth Embodiment

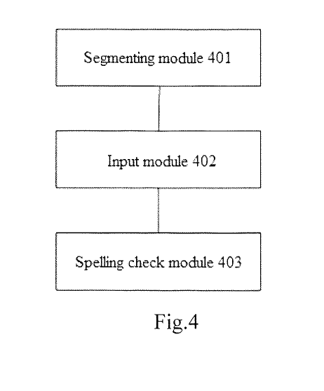

As shown in FIG. 4, a Tibetan spelling check device based on automata provided by the embodiment of the present invention includes:

a segmenting module 401, used for segmenting a Tibetan text to be checked with an character as a unit to acquire at least one Tibetan character;

an input module 402, used for using the at least one Tibetan character as the input of a preset finite state automaton group;

a spelling check module 403, used for judging whether the Tibetan text to be checked is correctly spelled through the finite state automaton group;

the finite state automaton group includes 37 finite state automata, wherein any finite state automaton Mᵢ=(Σᵢ, Qᵢ, qᵢ, Fᵢ); the Σᵢ represents a finite set of terminal symbols of a preset Tibetan spelling formal grammar G₁; the Qᵢ represents a union of a finite set Vᵢ of non-terminal symbols of the Tibetan spelling formal grammar Gᵢ and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ, and Fᵢ⊂Qᵢ; and the i is a positive integer, and i≦37.

In the embodiment, the process of implementing the Tibetan spelling check through the segmenting module, the input module and the spelling check module is similar to that provided by the first embodiment to the third embodiment of the present invention, and thus will not be repeated redundantly herein.

The present invention has the following beneficial effects: the Tibetan text to be checked is used as the input of the finite state automaton group to achieve Tibetan spelling check. As the finite state automaton group corresponds to the Tibetan spelling formal grammar, the technical solutions provided by the embodiments of the present invention can solve the problem in the prior art that when the spelling check is carried out by a model, as the application range of the model is relatively narrow, some Tibetan characters with special structures cannot be recognized.

The order of the above embodiments is only for the purpose of convenient description, and does not represent the advantages and disadvantages of the embodiments.

Finally, it should be noted that the above embodiments are merely used for illustrating the technical solutions of the present invention, rather than limiting them; although the present invention has been described in detail with reference to the foregoing embodiments, those of ordinary skill in the art should understand that they could still make modifications to the technical solutions recorded in the foregoing embodiments or make equivalent substitutions to a part of technical features therein; and these modifications or substitutions do not make the essence of the corresponding technical solutions depart from the spirit and the scope of the technical solutions of the embodiments of the present invention.

1. A Tibetan spelling check method based on automata, comprising:
S10, segmenting a Tibetan text to be checked with an character as a unit to acquire at least one Tibetan character;
S20, using the at least one Tibetan character as the input of a preset finite state automaton group; and
S30, judging whether the Tibetan text to be checked is correctly spelled through the finite state automaton group;
wherein the finite state automaton group comprises 37 finite state automata, and any finite state automaton Mᵢ=(Σᵢ, Qᵢ, δᵢ, qᵢ, Fᵢ); the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ, and Fᵢ⊂Qᵢ; and the i is a positive integer, and i≦37.

2. The Tibetan spelling check method based on the automata of claim 1, wherein after the S30, the method further comprises:
S40, judging whether the Tibetan text to be checked is completely checked; and if not, the S20 is continuously executed on the unchecked part of the Tibetan text to be checked.

3. The Tibetan spelling check method based on the automata of claim 1, wherein the S10 comprises:
segmenting the Tibetan text to be checked with an character as a unit according to a Tibetan character separator, a vertical character, a double-vertical character and a space character to acquire at least one Tibetan character.

4. The Tibetan spelling check method based on the automata of claim 1, wherein before the S20, the method further comprises:
S11, acquiring the Tibetan spelling formal grammar Gᵢ, wherein the Gᵢ=(Tᵢ, Vᵢ, Sᵢ, Pᵢ);
S12, acquiring a termination state identifier Eᵢ of the finite state automaton group Mᵢ;
S13, judging whether a finite set Pᵢ of production rules of the Tibetan spelling formal grammar Gᵢ contains a production rule Sᵢ→λ;
S14, if so, acquiring Fᵢ with values of Sᵢ and Eᵢ;
S15, if not, acquiring Fᵢ with a value Eᵢ; and
S16, acquiring the finite state automaton Mᵢ according to the Tᵢ, Vᵢ, Sᵢ and Fᵢ;
Tᵢ represents the finite set of the terminal symbols of the Tibetan spelling formal grammar Gᵢ; Sᵢ represents a start symbol of the Tibetan spelling formal grammar Gᵢ; SᵢεVᵢ; λ represents a null character; and
a finite set Σᵢ of the input characters of the finite state automaton Mᵢ is equivalent to the finite set Tᵢ of the terminal symbols of the Tibetan spelling formal grammar Gᵢ; and the initial state qᵢ of the finite state automaton Mᵢ is equivalent to the start symbol Sᵢ of the Tibetan spelling formal grammar Gᵢ.

5. The Tibetan spelling check method based on the automata of claim 4, wherein the S11 comprises:
S111, acquiring the finite set Tᵢ of the terminal symbols, wherein Tᵢ is a subset of a set L, and the set L comprises 30 Tibetan consonants, 5 reverse scripts, 4 vowel symbols and 1 long vowel symbol;
S112, acquiring the finite set Vᵢ of the non-terminal symbols;
S113, acquiring the start symbol Sᵢ, wherein SᵢεVᵢ;
S114, acquiring the finite set Pᵢ of the production rules; and
S115, acquiring the corresponding Tibetan spelling formal grammar Gᵢ according to the Tᵢ, Vᵢ, Sᵢ and Pᵢ.

6. The Tibetan spelling check method based on the automata of claim 5, wherein the S114 comprises:
S1141, acquiring a preset Tibetan spelling grammar formal description system; and
S1142, acquiring the finite set Pᵢ of the production rules according to the Tibetan spelling grammar formal description system.

7. The Tibetan spelling check method based on the automata of claim 4, wherein the S12 comprises:
S121, judging whether the finite set Pᵢ of the production rules of the Tibetan spelling formal grammar Gᵢ contains a production rule B→x, wherein BεVᵢ, and xεTᵢ; and
S122, if so, acquiring Eᵢεδᵢ (B, x), wherein δᵢ (B, x)=φ.

8. The Tibetan spelling check method based on the automata of claim 1, wherein the S30 comprises:
S301, sequentially receiving, by each finite state automaton in the finite state automaton group, the at least one Tibetan character from the initial state and transferring the state;
S302, if a certain finite state automaton in the finite state automaton group can enter the termination state after transferring the state, indicating that the Tibetan text to be checked is correctly spelled; and
S303, if none of the finite state automata in the finite state automaton group can enter the termination state after transferring the state, indicating that the Tibetan text to be checked is wrongly spelled.

9. A Tibetan spelling check device based on automata, comprising:
a segmenting module, used for segmenting a Tibetan text to be checked with an character as a unit to acquire at least one Tibetan character;
an input module, used for using the at least one Tibetan character as the input of a preset finite state automaton group;
a spelling check module, used for judging whether the Tibetan text to be checked is correctly spelled through the finite state automaton group;
the finite state automaton group comprises 37 finite state automata, wherein any finite state automaton Mᵢ=(Σᵢ, Qᵢ, δᵢ, qᵢ, Fᵢ); the Σᵢ represents a finite set of terminal symbols of a preset Tibetan spelling formal grammar Gᵢ; the Qᵢ represents a union of a finite set Vᵢ of non-terminal symbols of the Tibetan spelling formal grammar Gᵢ and the Fᵢ; the δᵢ represents a state transition function of the finite state automaton Mᵢ acquired by mapping from a direct product Qᵢ*Σᵢ of Qᵢ and Σᵢ to Qᵢ; the qᵢ represents an initial state of the finite state automaton Mᵢ; qᵢεQᵢ; the Fᵢ represents a finite set of termination states of the finite state automaton Mᵢ, and Fᵢ⊂Qᵢ; and the i is a positive integer, and i≦37.
